(19) United States
(12) Patent Application Publication
(10) Pub. No.: US 2011/0022204 A1
(43) Pub. Date: Jan. 27, 2011

(54) AUDIO CIRCUIT

(76) Inventor: Robert James Hatfield, Edinburgh (GB)

Correspondence Address: DICKSTEIN SHAPIRO LLP, 1825 EYE STREET NW, Washington, DC, 20006-5403, US

(21) Appl. No.: 12/839,753

(22) Filed: Jul. 20, 2010

(30) Foreign Application Priority Data
Jul. 24, 2009 (GB) 0912956.0

(51) Int. Cl. G06F 17/00; G06F 13/14

(52) U.S. Cl. 700/94; 710/305

(57) ABSTRACT

An integrated circuit 39 for transferring audio signals between audio transducers and circuits that supply or receive digital audio signals, suitable for use for example in a portable, battery powered telecommunications device such as a mobile telephone, smartphone or portable digital assistant with telephone capability, comprises at least two sets of interface connectors 40a, 40b, 40c for connecting to digital audio buses or links 38a, 38b, 38c for communicating digital audio signals with the external circuits 31, 33 37, and at least one digital audio interface circuit 43, 45 for converting the audio signals between the format used by the data link 38a, 38b, 38c and the format used within the integrated circuit 39 (such as conversion between serial and parallel and multiplexing/demultiplexing multiple data channels that are time division multiplexed onto the data link). A routing system 74 is connected between the interface connectors 40a, 40b, 40c and the digital audio interface circuit or circuits 43, 45. The routing system 74 is operable to route signals passing through a first set of interface connectors 40b so as to pass through a first digital audio interface circuit 45 and is operable to route signals passing through a second set of interface connectors 40c so as to pass through the first digital audio interface circuit 45 or alternatively is operable to route signals passing through the second set of interface connectors 40c so as to pass through the first set of interface connectors 40b without passing through any digital audio interface circuit as the signals pass between the first and second sets of interface connectors 40b, 40c, or alternatively is operable to perform both routings.

The present invention relates to an integrated circuit suitable for transferring or processing digital audio data, such as a circuit for transferring audio signals between audio transducers and circuits suitable for receiving in digital form audio signals created by input transducers (e.g. microphones) and for providing in digital form audio signals to be sent to output transducers (e.g. speakers). Preferably, the circuit is suitable for use in a hand-held portable device, and most preferably a device having cellular or mobile telephony capabilities, such as a mobile telephone, a portable digital assistant with cellular telephone capability, so-called “smartphones”, and other device representing the convergence of mobile telephones with portable music players and/or hand-held computing devices. Such devices are typically powered by internal batteries. The present invention also relates to methods or using such audio circuits and methods of routing and processing signals within such circuits, and also relates to devices using such circuits.

Such circuits have usually been known in the past as audio codecs, since the major function of such integrated circuits was originally to provide analog-to-digital and digital-to-analog conversion between analog audio transducers and the circuits that received and provided digital audio signals. However, such circuits are now sometimes referred to as audio hubs, in view of the signal routing and mixing capabilities that are often available in more recent such circuits. Furthermore, it is not a requirement of the present invention that the audio integrated circuit necessarily includes an analog-to-digital and digital-to-analog conversion ability, since the emergence of digital microphones and digital speakers (which may in practice be the combination of an analog transducer together with a converter in a single package rather than a transducer that converts directly to and from digital signals) provides the possibility that all of the signals between the integrated circuit and the transducers may be in digital form. However, it is anticipated that audio devices such as mobile telephones will normally continue to include analog transducers and so such audio integrated circuits will normally include an ability to handle analog signals and to convert audio signals between analog and digital form.

Such integrated circuits are typically connected in practice to the circuits that receive and supply the digital audio signals by audio data buses or other wiring links (typically provided on a printed circuit board) that are connected to the integrated circuit by connectors (which are commonly known as pins, even though the physical form of the connectors in a particular encapsulation of the integrated circuit do not necessarily take the physical form of pins but may be balls, tabs or other shapes convenient for mounting the integrated circuit). In practice, the integrated circuit is normally encapsulated in order to protect it, and connection pads on the integrated circuit chip are electrically connected to the connectors (pins) on the outside of the encapsulation. The digital audio signals are normally sent over the bus or other link in accordance with a standard signal format and will also comply with rules concerning such matters as signal timing. These rules concerning format, timing and so on are defined in the data transfer protocol used to transfer the audio signals, and the link will comprise several conductor lines or wires having functions defined in the protocols. For example, there will be one or more conductor lines carrying data and typically one or more conductor lines carrying timing signals usually known as clocks.

Although digital audio processing circuits will normally convey digital audio data internally in parallel form, the protocols for data transfer between circuits typically specify data transfer in serial form, so as to reduce the number of connector lines required between different circuits. Different protocols transfer the data according to different rules. For example, one data protocol may transfer serial digital data in words with the least significant bit first and another protocol may transfer serial data in words with the most significant bit first. Some data transfer protocols (such as PCM) include provision for multiple data channels to be time-division multiplexed over the same serial data line, whereas in other protocols (such as I²S) only two channels (left and right stereo) are possible. Additionally, the data transfer protocol may define data transfer in packets including one or more header bits, control bits, check bits or other bits, in addition to the actual data being transferred (as in the AC'97 protocol). Consequently, within a typical audio integrated circuit for transferring audio signals between transducers and external circuits (i.e. circuits external to the audio integrated circuit) for receiving or supplying digital audio data, a set of connectors used for connecting to a digital audio bus or link will normally be connected within the integrated circuit directly to a digital audio interface circuit. The main function of the digital audio interface circuit is to convert data between parallel and serial form (assuming that the integrated circuit uses parallel data internally and the link uses serial data), according to the rules for the data transfer protocol being used in the link.

In order to provide flexibility of use for the integrated circuit, the digital audio interface circuit may be designed so that it can work with more than one data transfer protocol, and the integrated circuit has control logic for controlling the operation of the digital audio interface circuit in accordance with a control setting that determines the data transfer protocol being used. Accordingly, it can be understood that it is possible to draw a distinction between the interface connectors, which may for example be the integrated circuit connection pads and corresponding external connectors of the encapsulated chip, for connection to the audio bus or other audio data link, on the one hand, and the digital audio interface circuit on the other hand.

According to one aspect of the present invention there is provided an integrated circuit for transferring audio signals between one or more audio transducers and circuits for supplying, in digital form, audio signals to be output to a transducer or for receiving, in digital form, audio signals input from a transducer, the integrated circuit comprising at least one set of interface connectors for connecting the integrated circuit to another circuit for transfer of digital audio signals (typically together with timing and/or control signals) therebetween according to a data transfer protocol, and at least two digital audio interface circuits for converting digital audio signals between the protocol used for transfer of digital data to or from another circuit via the said set of interface connectors and a protocol for the transfer of digital audio data internally within the integrated circuit, or alternatively comprising at least two sets of interface connectors and at least one digital audio interface circuit, the integrated circuit comprising a signal route selection system connected between the digital audio interface circuit or circuits on the one hand and the set or sets of interface connectors on the other hand, and operable to select which digital audio interface circuit is coupled to a set of interface connectors, out of a plurality of interface connectors that are couplable to the digital audio interface circuit, or alternatively to select which digital audio interface circuit is coupled to a set of interface connectors out of a plurality of digital audio interface circuits that are couplable to the set of interface connectors.

Preferably, the integrated circuit has at least two digital audio interface circuits and at least two sets of interface connectors, and at least one digital audio interface circuit can be coupled selectively either to one set of interface connectors or to another set of interface connectors, and at least one set of interface connectors can be coupled selectively either to one digital audio interface circuit or to another digital audio interface circuit. More preferably, there are at least two digital audio interface circuits and at least two sets of interface connectors, and the signal routing system allows a first digital audio interface circuit to be coupled either to a first set of interface connectors or to a second set of interface connectors, and allows a second digital audio interface circuit to be coupled to the first set of interface connectors or to the second set of interface connectors, so as to allow the first digital audio interface to be coupled to the first set of interface connectors and allow simultaneously the second digital audio interface circuit to be coupled to the second set of interface connectors, and also to allow the first digital audio interface circuit to be coupled to the second set of interface connectors and simultaneously to allow the second digital audio interface circuit to be coupled to the first set of interface connectors.

This arrangement allows flexibility so that signals from a particular external circuit, connected to a particular set of interface connectors, can be routed selectively to one or another digital audio interface circuit, as required, or to allow a particular digital audio interface circuit to be coupled, through one or another set of interface connectors, to one or another external circuit, and this arrangement can be changed without changing the wiring connections in the overall device that contains the integrated circuit and the other external circuits. This flexibility may be useful, for example, where the integrated circuit contains two or more digital audio interface circuits having different capabilities, such as the ability to handle different protocols for digital data transfer or the ability to handle different numbers of digital data channels multiplexed onto the same set of interface connectors, or where the integrated circuit is connected internally to enable different forms of processing to be available to signals received via different digital audio interface circuits.

In another aspect the present invention provides an integrated circuit for transferring audio signals between audio transducers and circuits for providing or receiving audio signals in digital form, the integrated circuit comprising at least one digital audio interface circuit and at least two sets of interface connectors, there being a greater number of sets of interface connectors than of digital audio interface circuits, and at least one digital audio interface circuit is selectively couplable either to a first set of interface connectors or to a second set of interface connectors. In this way, the integrated circuit can be coupled to send digital audio data to, or receive digital audio data from, the greater number of external circuits than it has digital audio interface circuits, with different external circuits being coupled to a digital audio interface circuit at different times. This enables the integrated circuit to interface with a number of external circuits while avoiding cost and complexity by containing a reduced number of digital audio interface circuits. In one embodiment, each digital audio interface circuit is selectively couplable to each set of interface connectors, but this feature is not essential.

In another aspect of the present invention there is provided an integrated circuit for transferring audio signals between audio transducers and other circuits for supplying or receiving audio signals in digital form, the integrated circuit comprising at least one digital audio interface circuit and at least two sets of interface connectors, the digital audio interface circuit being couplable to at least one of the sets of interface connectors, and at least the data connector or connectors of the first and second sets of interface connectors being couplable to each other by a route that does not pass through any digital audio interface circuit. Typically, the audio data passing through a set of interface connectors is accompanied by other signals, such as clock or synchronisation signals which may for instance indicate the timing of the audio data or other signals, or control or routing signals which may for instance include data package headers and error detection data, or other data. Typically, a timing signal such as a clock or synchronisation signal will be provided on a different connector of the set from the audio data signal(s). Preferably, at least some timing signal (clock) connectors of the sets of interface connectors are couplable to each other by a route that does not pass through any digital audio interface.

This opens the possibility for digital audio signals received from one external circuit to be received by the integrated circuit over one set of interface connectors and transmitted on to another external circuit through another set of interface connectors without the audio signal passing through any digital audio interface circuit of the integrated circuit and therefore without the digital audio signal passing through any of the other circuitry of the integrated circuit on the side of the digital audio interface circuit remote from the interface connectors. It may also be possible to branch the received digital audio signal additionally to a digital audio interface circuit if it is desired also to transmit the digital audio signal along a parallel path within the integrated circuit simultaneously with forwarding it to another circuit. For example, received audio in a telephone conversation may be provided to the integrated circuit from a baseband processor (communications processor), and this received audio may simultaneously be transferred directly to an applications processor, without passing through any digital audio interface of the integrated circuit, to enable the incoming audio to be recorded in a memory, and simultaneously the incoming audio may branch to a digital audio interface circuit and be transferred by the integrated circuit to a speaker or other output transducer.

Additionally, the connection between the connectors of different sets of interface connectors without passing through a digital audio interface circuit may be used to enable a digital audio signal output from the integrated circuit through a digital audio interface circuit to be branched so as to be provided to more than one external circuit, while only using one digital audio interface circuit of the integrated circuit. For example, audio for a telephone conversation received by the integrated circuit from a transducer such as a microphone may be provided simultaneously to a baseband processor (communications processor) for transmission to the telephone network in the telephone call while simultaneously being transferred to an applications processor to be recorded in a memory.

It may not always be possible to route signals from one digital audio interface circuit to two sets of interface connectors simultaneously, or to route signals from one set of interface connectors to another set of interface connectors without going via a digital audio interface circuit, for example where the operations of the two external circuits connected to the two sets of interface connectors are incompatible in some way. For example, for such an arrangement to work the two external circuits would normally have to be operating synchronously, and be arranged to communicate data at the same data rate using the same data transfer protocol, and at least one of the external circuits would have to be operable in slave mode (i.e. operable to time its interaction with the data on the data bus or link in accordance with clock signals received over the bus or link). Nevertheless, circumstances are possible in which two external circuits are compatible with each other so that this kind of signal routing could be used. Various possible advantages may be obtained. For example, in the case where signals are to be transferred from one external circuit to another external circuit, without the need for any processing in the integrated circuit for communicating with audio transducers, but those two external circuits have no direct connection with each other, the integrated circuit may nevertheless enable the audio signal to be transferred from one external circuit to the other without the signal passing through any digital audio interface circuit or processing circuits of the integrated circuit. This can avoid unnecessary power consumption since unnecessary operation of circuitry within the integrated circuit is avoided. Additionally, it avoids unnecessary use of digital audio paths through the integrated circuit, thereby freeing paths through the digital audio interface circuits and other circuits within the integrated circuit which may be required for simultaneous processing of different audio signals. This can be a matter of practical importance since there will typically be a limit to the number of simultaneous independent audio paths through the integrated circuit (for reasons of cost if nothing else), but on the other hand it is desirable for a mobile telephony device to handle multiple independent audio data streams simultaneously (for example, when the device is mounted in a car it may be required to handle telephone calls, satellite navigation commands and in-car entertainment audio simultaneously), and so the overall performance and flexibility of the device can be improved if audio signals that do not require processing within the integrated circuit can be routed so as not to occupy data paths through the integrated circuit which might obstruct the routing of other audio signals.

In another aspect of the present invention there is provided an integrated circuit for transferring audio signals between (i) audio transducers and (ii) circuits for supplying and/or receiving digital audio signals, the integrated circuit comprising:
(a) at least a first set of interface connectors and a second set of interface connectors, each set of interface connectors being suitable for connection to an audio data link for transferring digital audio data between the integrated circuit and one of the said circuits for supplying and/or receiving digital audio signals;
(b) at least a first digital audio interface circuit, for processing signals that pass through one of the said sets of interface connectors so as to convert the audio data of the signals between the data format used in the audio link to which the set of interface connectors is connected and a data format usable within the integrated circuit; and
(c) a routing system connected between the said sets of interface connectors and the said digital audio interface circuit and arranged to select a route, from a plurality of available routes, for audio data signals passing through the said first set of interface connectors.

In another aspect of the present invention there is provided an integrated circuit for transferring audio signals between (i) audio transducers and (ii) circuits for supplying and/or receiving digital audio signals, the integrated circuit comprising:
(a) at least a first set of interface connectors and a second set of interface connectors, each set of interface connectors being suitable for connection to an audio data link for transferring digital audio data between the integrated circuit and one of the said circuits for supplying and/or receiving digital audio signals;
(b) at least a first digital audio interface circuit and a second digital audio interface circuit, each digital audio interface circuit being suitable for processing signals that pass through one of the said sets of interface connectors so as to convert the audio data of the signals between the data format used in the audio link to which the set of interface connectors is connected and a data format usable within the integrated circuit; and
(c) a routing system connected between the said sets of interface connectors and the said digital audio interface circuit and arranged to select a route, from a plurality of available routes, for audio data signals passing through the said first set of interface connectors and to select a route, from a plurality of available routes, for audio data signals passing through the said second set of interface connectors,
the routing system being arranged, in a first mode, to route audio data signals passing through the first set of interface connectors along a route passing through the first digital interface circuit and to route audio data signals passing through the second set of interface connectors along a route passing through the second digital interface circuit, and being arranged, in a second mode, to route audio data signals passing through the first set of interface connectors along a route passing through the second digital interface circuit and to route audio data signals passing through the second set of interface connectors along a route passing through the first digital interface circuit.

In another aspect of the present invention there is provided an integrated circuit for transferring audio signals between (i) audio transducers and (ii) circuits for supplying and/or receiving digital audio signals, the integrated circuit comprising:
(a) at least a first set of interface connectors and a second set of interface connectors, each set of interface connectors being suitable for connection to an audio data link for transferring digital audio data between the integrated circuit and one of the said circuits for supplying and/or receiving digital audio signals;
(b) at least a first digital audio interface circuit, for processing signals that pass through one of the said sets of interface connectors so as to convert the audio data of the signals between the data format used in the audio link to which the set of interface connectors is connected and a data format usable within the integrated circuit; and
(c) a routing system connected between the said sets of interface connectors and the said digital audio interface circuit and arranged to provide, for audio data signals passing through the said first set of interface connectors, a route passing through the second set of interface connectors without passing through any digital audio interface circuit on the route between the first and second sets of interface connectors.

In another aspect of the present invention there is provided a method of transferring digital audio data signals in a device comprising a plurality of audio transducers, a plurality of circuits for supplying and/or receiving digital audio signals, and an integrated circuit for transferring audio signals between the said audio transducers and the said circuits for supplying and/or receiving digital audio signals,
wherein the integrated circuit comprises:
(a) at least a first set of interface connectors connected to a first one of the said circuits for supplying and/or receiving digital audio signals by a first digital audio data link, and a second set of interface connectors connected to a second one of the said circuits for supplying and/or receiving digital audio signals by a second digital audio data link; and
(b) at least a first digital audio interface circuit, for processing signals that pass through one of the said sets of interface connectors so as to convert the audio data of the signals between the data format used in the audio link to which the set of interface connectors is connected and a data format usable within the integrated circuit
the method comprising transferring first digital audio signals from the first said circuit for supplying and/or receiving digital audio signals to the second said circuit for supplying and/or receiving digital audio signals by:
(i) passing the first digital audio signals along the first digital audio data link to the first set of interface connectors of the said integrated circuit;
(ii) passing the first digital audio signals from the said first set of interface connectors to the second set of interface connectors without passing through any digital audio interface circuit on the route between the first and second sets of interface connectors; and
(iii) passing the first digital audio signals along the second digital audio data link to the second said circuit for supplying and/or receiving digital audio signals.

In another aspect of the present invention there is provided an integrated circuit for transferring audio signals between (i) audio transducers and (ii) circuits for supplying and/or receiving digital audio signals, the integrated circuit comprising:
(a) N sets of interface connectors, each set of interface connectors being suitable for connection to an audio data link for transferring digital audio data to or from one of the said circuits for supplying and/or receiving digital audio signals, wherein N is a number greater than 1;
(b) M first digital audio interface circuits for processing signals that pass through the said sets of interface connectors so as to convert the audio data of the signals between the data format used in the audio link to which the set of interface connectors is connected and a data format usable within the integrated circuit, wherein M is a number greater than zero and less than N; and
(c) a routing system connected between the said sets of interface connectors and the said digital audio interface circuit and arranged to provide, for signals passing through each of the N sets of interface connectors, at least one of: (i) a route passing through another of the N sets of interface connectors without passing through any digital audio interface circuit on the route between the respective sets of interface connectors; and (ii) a route passing through one of said M digital audio interface circuits.

An aspect of the present invention may provide an integrated circuit for processing at least audio (digital) data comprising:
at least first and second sets of terminals via which digital signals may be input and/or output, said digital signals comprising audio data signals;
a configurable coupling network or routing system;
a data bus for transferring said audio data signals; and
at least one audio data interface coupled between said coupling network and said data bus for operably processing, in use, at least said audio data signals so as to convert between at least first and second signal formats;
wherein said coupling network is operably configured, in use, to select a coupling, from a plurality of available couplings, for said digital signals between said at least first and second sets of terminals and said interface.

An aspect of the present invention may provide an integrated circuit such as an audio hub comprising:
at least first and second sets of terminals for inputting and/or outputting digital signals comprising audio data signals;
routing circuitry (e.g. for routing said digital signals);
a data bus for transferring said audio data signals; and
at least one audio data interface coupled between said routing circuitry and said data bus;
wherein said routing circuitry is operably controlled, in use, to select a route, from a plurality of available routes (e.g. routes through the routing circuitry), for said digital signals. The routing circuitry may be coupled between the said sets of terminals and the audio data interface.

An aspect of the present invention may provide an integrated circuit such as an audio hub, having a routing system between (a) one or more sets of terminals for inputting to the audio hub, and/or outputting from the audio hub, digital audio data and associated control and/or timing data and (b) one or more interface circuits for handling data passing through the terminals, so that there is a choice of routes for data passing through the terminals.

An aspect of the present invention may provide an integrated circuit such as an audio hub, having a routing system between (a) one or more sets of terminals for inputting to the audio hub, and/or outputting from the audio hub, digital audio data and associated control and/or timing data and (b) one or more interface circuits for handling data passing through the terminals, so that data received through a set of terminals may be routed to be output through another set of terminals without passing through any of the interface circuits on its path between the sets of terminals.

The choice of routes need not be the same for all the signals passing through a set of terminals at the same time. For example, data in one direction may be routed via an interface circuit while data in a reverse direction is routed out of the integrated circuit without passing through an interface circuit, or audio data may be routed out of the integrated circuit without passing through an interface circuit while timing or control data passes through an interface circuit.

An aspect of the present invention may provide an integrated circuit such as an audio hub in which, for digital audio data (possibly with associated timing and/or control signals) entering or leaving the integrated circuit, a routing system is able to switch over which interface circuit of the integrated circuit handles signals entering or leaving the integrated circuit through which set of interface connectors.

An aspect of the present invention may provide an integrated circuit such as an audio hub, having more sets of terminals for inputting to the audio hub, and/or outputting from the audio hub, digital audio data and associated control and/or timing data than it has interface circuits for handling data passing through the terminals, and at least one of the interface circuits can be coupled so as to handle, at different times, data passing through different sets of terminals.

The interfaces (interface circuits) may be used to interface audio data between the circuitry inside the audio hub and circuitry outside the audio hub, for example by converting between data formats or data timing, such as serial/parallel conversion.

As previously mentioned, the audio data passing through a set of terminals or connectors is usually accompanied by other signals, such as clock signals or synchronisation signals which may for instance indicate the timing of the audio data or other signals, or control or routing signals which may for instance include data package headers and error detection data, or other data. Therefore, when an external circuit communicates digital audio data over an audio data link to or from the connectors of the integrated circuit, it will normally also be communicating such additional signals or data. Typically, a timing signal (clock signal or synchronisation signal) will be provided on a different connector of the set from the audio data signal(s), and the audio data link will typically include both at least one conductor for carrying audio data (possibly with other data) and at least one conductors for carrying another signal such as a timing signal.

Various aspects of the invention and optional features are set out in the claims, which are hereby incorporated by reference into the description.

Embodiments of the present invention provide an integrated circuit for transferring audio signals between audio transducers and circuits that supply or receive digital audio signals, suitable for use for example in a portable, battery powered telecommunications device such as a mobile telephone, smartphone or portable digital assistant with telephone capability, which comprises at least two sets of interface connectors for connecting to digital audio buses or links for communicating digital audio signals with the external circuits, and at least one digital audio interface circuit for converting the audio signals between the format used by the data link and the format used within the integrated circuit (such as conversion between serial and parallel and multiplexing/demultiplexing multiple data channels that are time division multiplexed onto the data link). A routing system is connected between the interface connectors and the digital audio interface circuit or circuits. The routing system is operable to route signals passing through a first set of interface connectors so as to pass through a first digital audio interface circuit and is operable to route signals passing through a second set of interface connectors so as to pass through the first digital audio interface circuit or alternatively is operable to route signals passing through the second set of interface connectors so as to pass through the first set of interface connectors without passing through any digital audio interface circuit as the signals pass between the first and second sets of interface connectors, or alternatively is operable to perform both routings.

In one embodiment, the integrated circuit has two digital audio interface circuits and three sets of interface connectors, and the routing system is operable to route signals passing through the first set of interface connectors so as to pass through the first digital audio interface circuit, is operable to route signals passing through the second set of interface connectors so as to pass through the second digital audio interface circuit or to pass through the third set of interface connectors without passing through any digital audio interface circuit as the signals pass between the second and third sets of interface connectors, and is operable to route signals passing through the third set of interface connectors so as to pass through the first digital audio interface circuit or to pass through the second digital audio interface circuit or to pass through the second set of interface connectors without passing through any digital audio interface circuit between the connectors.

In another embodiment, the integrated circuit has two digital audio interface circuits and two sets of interface connectors, and the routing system is operable so that signals passing through each set of interface connectors can be routed as desired through either digital audio interface circuit. Additional embodiments are also possible, as will be apparent from the drawings and the accompanying description.

The routing system enables various potential benefits in the design and operation of the integrated circuit. For example, it makes it possible to provide an integrated circuit that is capable of interfacing with a greater number of external circuits than it has digital audio interface circuits, thereby providing improved performance at reduced cost. Even when the number of digital audio interface circuits is the same as the number of sets of interface connectors, the ability to route signals passing through one of the digital audio interface circuits so as to pass through either one of two sets of interface connectors means that particular capabilities and processing functions may be provided for signals passing through both sets of connectors even in the case that those functions or processing abilities are only available within the integrated circuit to signals that pass through one particular digital audio interface circuit, thereby enabling improved performance at reduced cost.

The ability to route signals through one set of interface connectors directly to another set of interface connectors without passing through any digital audio interface circuit means that when signals are to be transferred from one external circuit to another external circuit without requiring any processing within the integrated circuit, this signal routing can be done without the signals occupying any audio paths through the internal circuitry of the integrated circuit, such as a digital processing core of the integrated circuit. This keeps all such audio paths through the internal circuitry free for carrying other audio signals, thereby improving the ability of the integrated circuit to handle multiple separate audio streams simultaneously.

The term “integrated circuit” is intended to refer both to IC chips themselves, and to encapsulated IC packages, and as such the terminals or connectors referred to above may for example be bond pads (connection regions) of an integrated circuit chip or may be connector pins, pads, balls or other electrical connection terminals of an encapsulated IC package.

The routing system may be regarded as, or may be implemented by, any suitable switching or coupling circuitry or combinatorial logic.

Typically, the audio data will be transferred over the data link to and from an external circuit in a serial format, and there may for example be four or five connectors in a set, including connectors for clock signals or other timing signals as well as connectors for carrying data in both directions. On the other hand, the digital audio data will normally be communicated within the audio hub integrated circuit in parallel form. Under these circumstances, the fact that the routing system routes the signals when they are outside (with respect to the main circuitry of the integrated circuit) the digital audio interface circuits means that the routing is performed on the serial data signals. Consequently, for a single set of connectors the routing logic is required to act only on e.g. four or five 1-bit wide signals in order to be able to route both data and timing signals (as opposed to acting on 32 lines for data alone if required to route 16-bit data with separate data input and output lines). This means that the routing logic can be implemented, even when the maximum possible number of routes is provided, within a reasonably small physical area of the integrated circuit. This helps to minimise manufacturing cost and prevents the routing system from taking up too much space that could otherwise be used for implementing other circuitry within the integrated circuit.

There are various known protocols specifying formats for the transfer of audio data over data links, and it is anticipated that other protocols may be developed in the future. The present invention is not limited to the use of any particular type of format or protocol. Known audio data link protocols and formats include I²S, PCH, AC'97, and Intel HAD. This list is not exhaustive.

It will be apparent that the various aspects of the present invention discussed above are compatible with each other, and an integrated circuit may be provided which simultaneously embodies multiple aspects of the present invention. For example, an integrated circuit may be able to route and reroute signals selectively between a digital audio interface circuit and any selected one of a plurality of sets of interface connectors, and may also be able to couple one set of interface connectors to another along a route that does not pass through a digital audio interface circuit, either at a different time or simultaneously with the selective routing and rerouting of signals between a digital audio interface circuit and sets of interface connectors.

Embodiments of the present invention, given by way of non-limiting example, will be discussed with reference to the accompanying drawings.

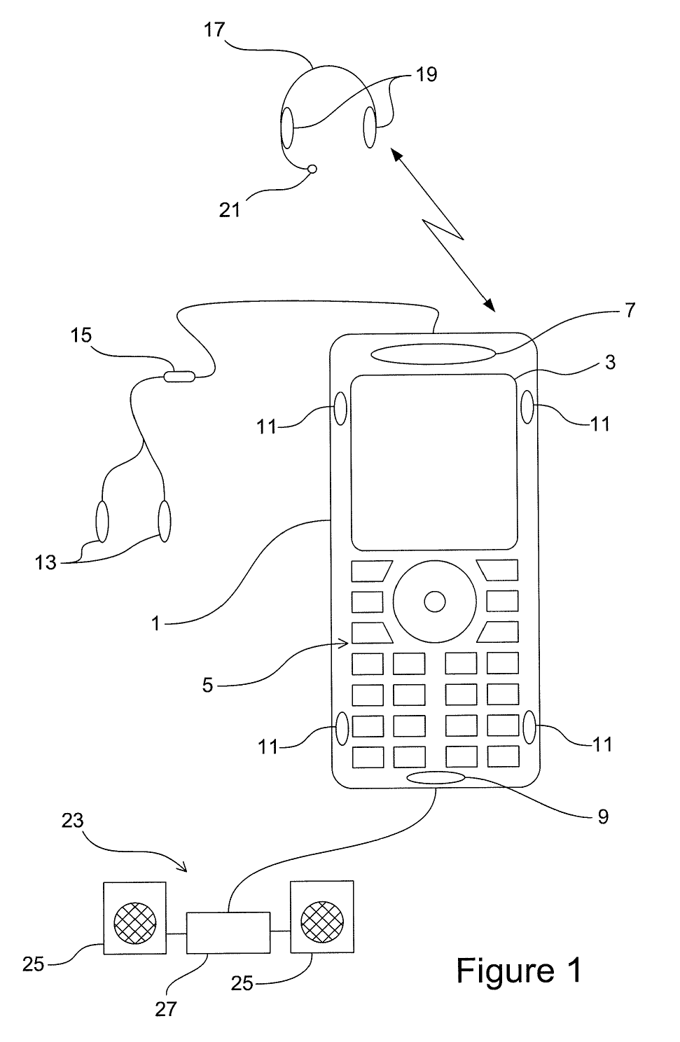

FIG. 1 shows a mobile telephone together with peripheral devices.

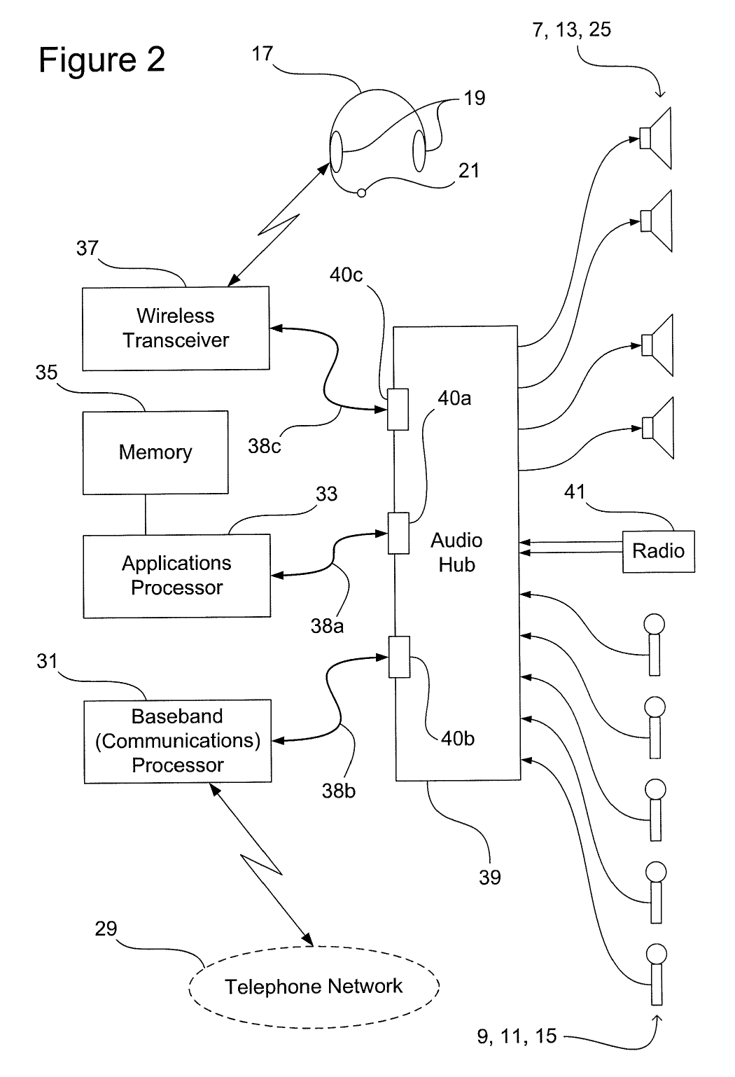

FIG. 2 shows the main components in the audio processing system of the mobile telephone of FIG. 1.

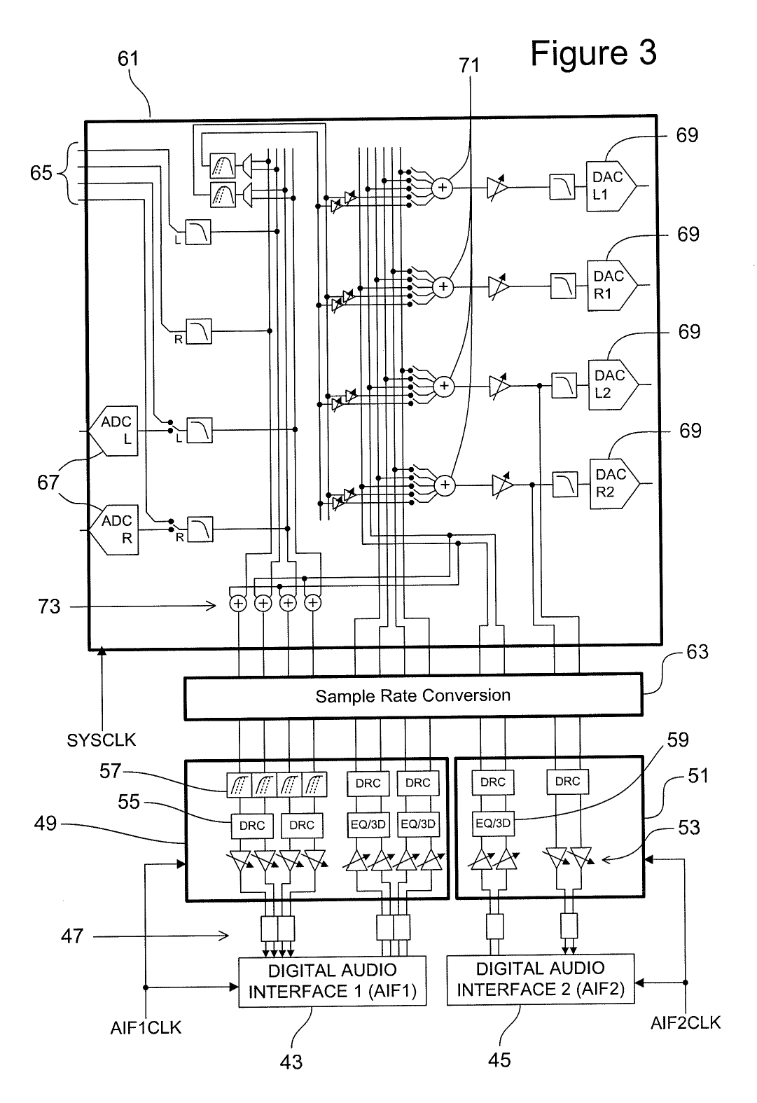

FIG. 3 shows the main digital processing circuits in the audio hub integrated circuit of the mobile telephone of FIG. 1.

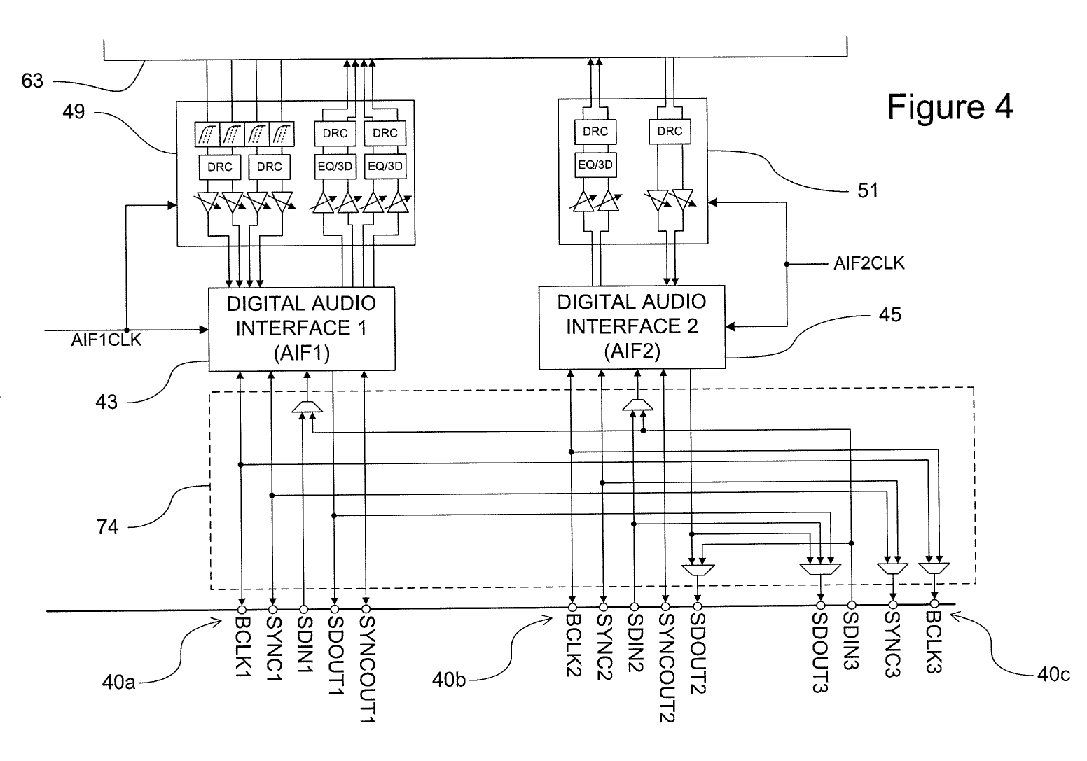

FIG. 4 shows the digital audio interface circuits and the associated interface connectors, together with the signal routing system between them, in the audio hub integrated circuit, according to a first embodiment of the present invention.

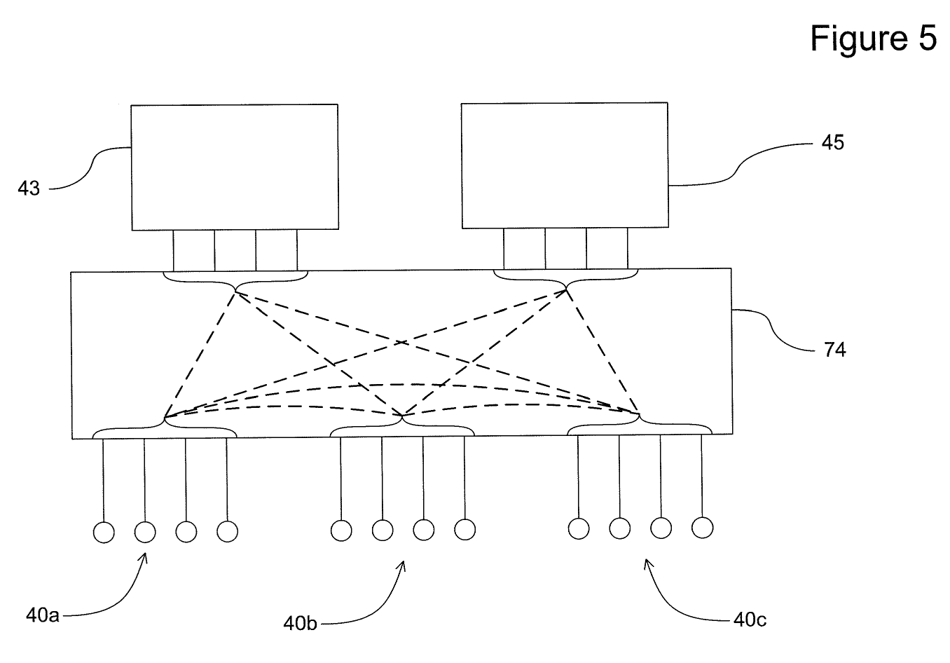

FIG. 5 shows a set of possible routes between two digital interface circuits and three sets of interface connectors in embodiments of the present invention.

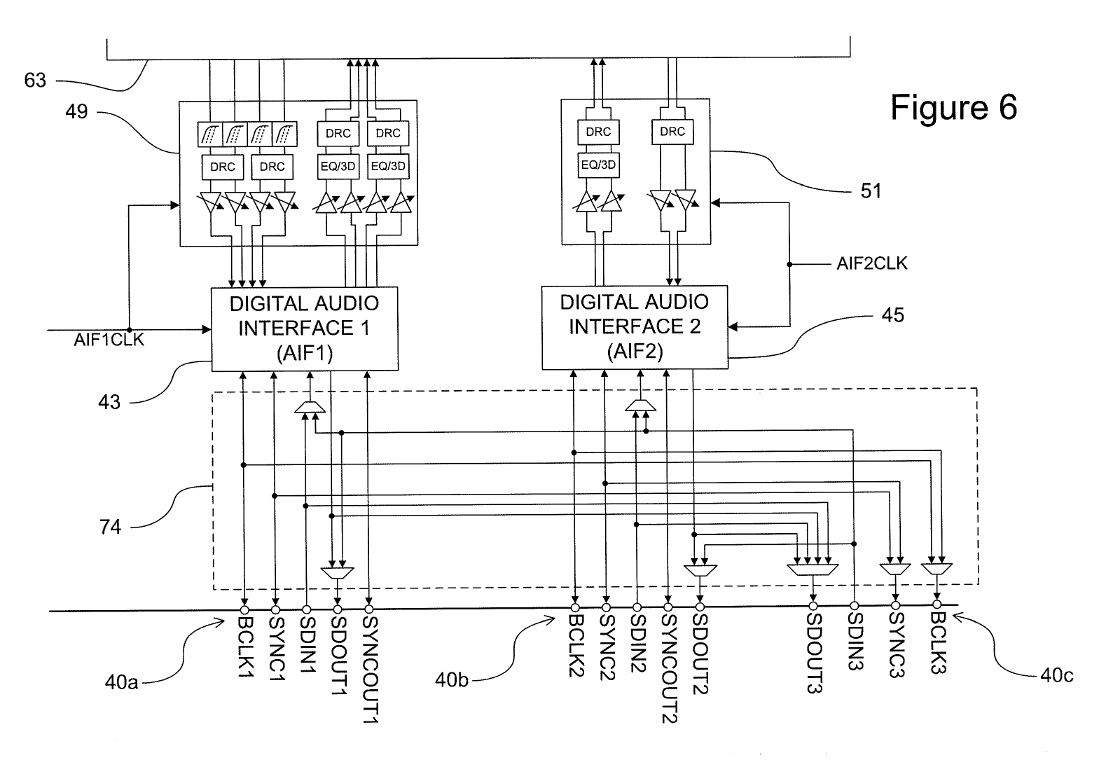

FIG. 6 shows the digital audio interface circuits and the associated interface connectors, together with the signal routing system between them, in the audio hub integrated circuit, according to a second embodiment of the present invention.

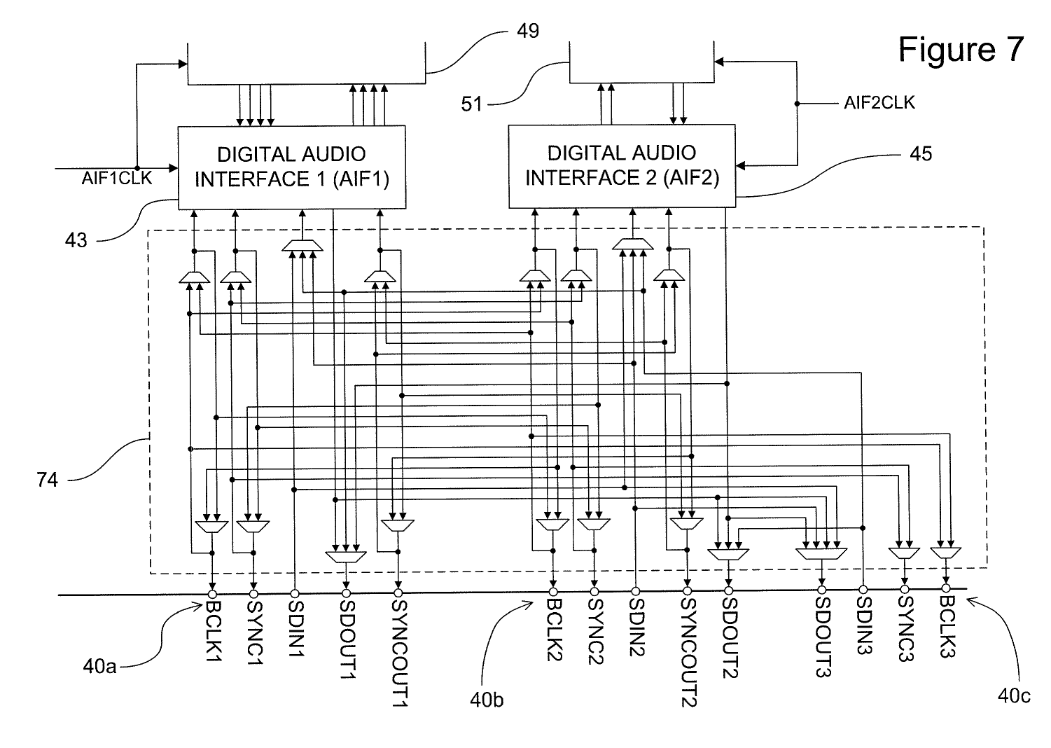

FIG. 7 shows the digital audio interface circuits and the associated interface connectors, together with the signal routing system between them, in the audio hub integrated circuit, according to a third embodiment of the present invention.

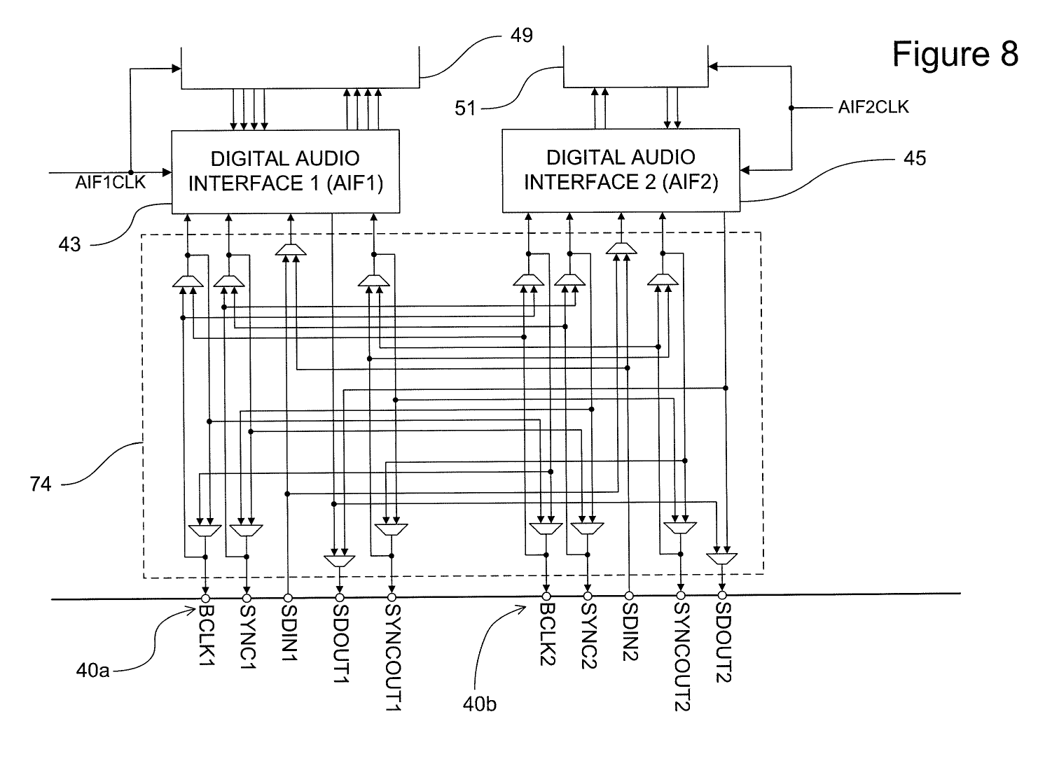

FIG. 8 shows the digital audio interface circuits and the associated interface connectors, together with the signal routing system between them, in the audio hub integrated circuit, according to a fourth embodiment of the present invention.

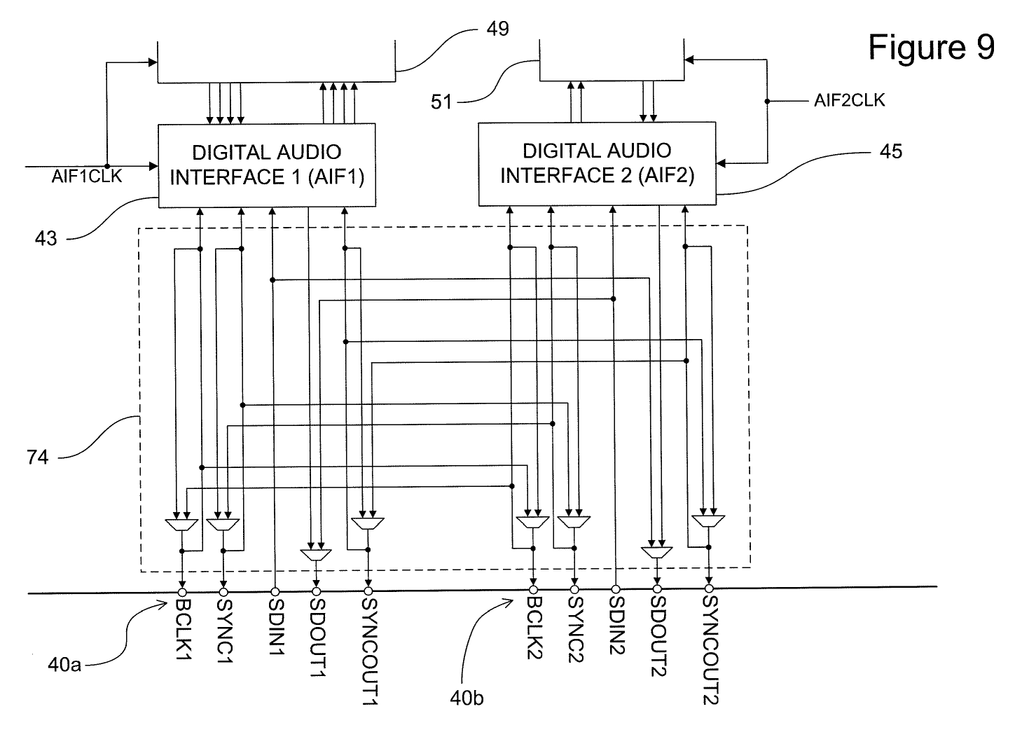

FIG. 9 shows the digital audio interface circuits and the associated interface connectors, together with the signal routing system between them, in the audio hub integrated circuit, according to a fifth embodiment of the present invention.

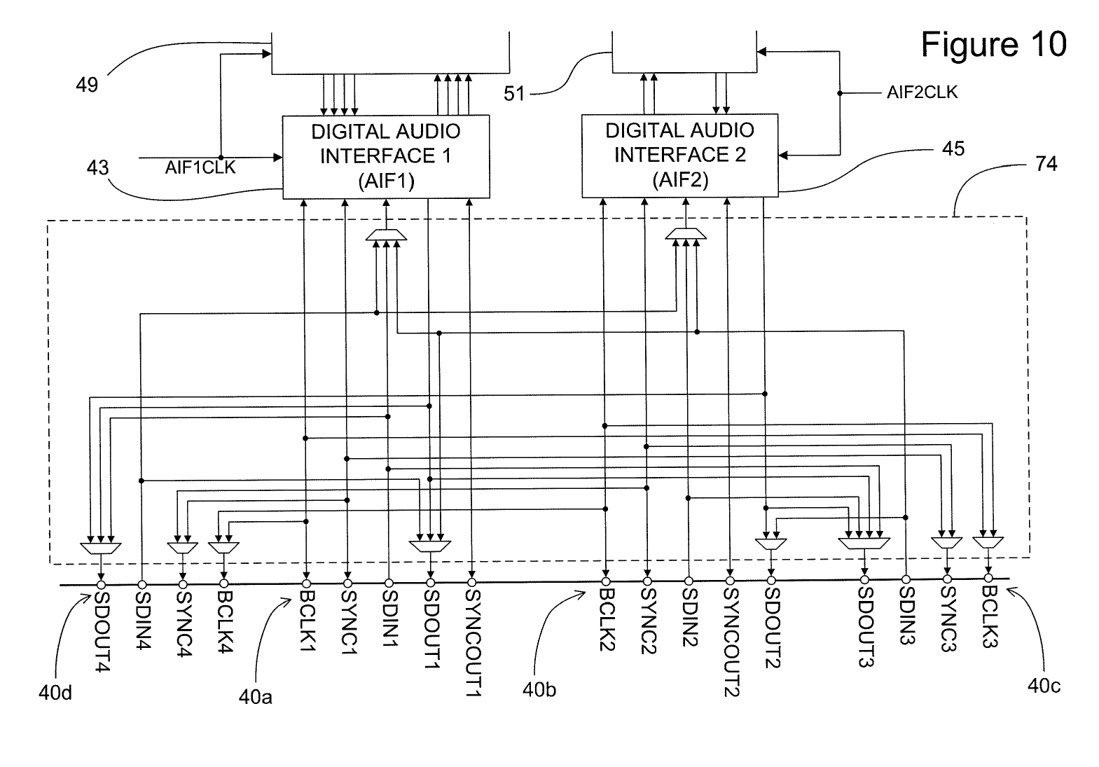

FIG. 10 shows the digital audio interface circuits and the associated interface connectors, together with the signal routing system between them, in the audio hub integrated circuit, according to a sixth embodiment of the present invention.

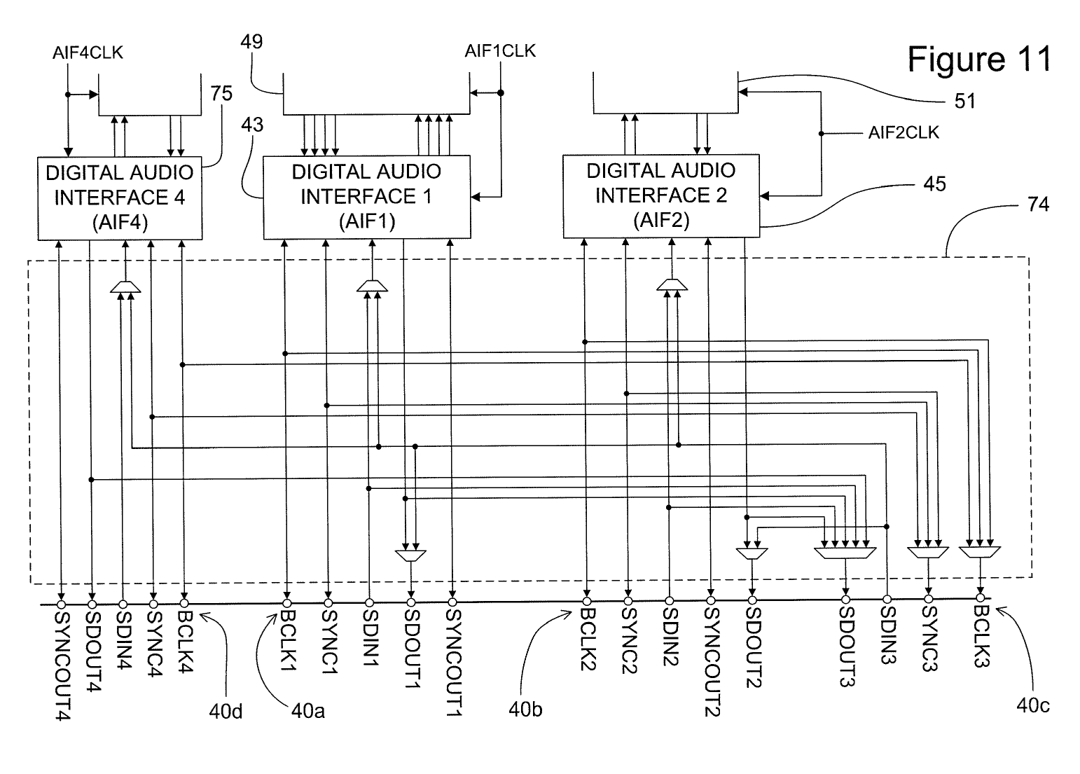

FIG. 11 shows the digital audio interface circuits and the associated interface connectors, together with the signal routing system between them, in the audio hub integrated circuit, according to a seventh embodiment of the present invention.

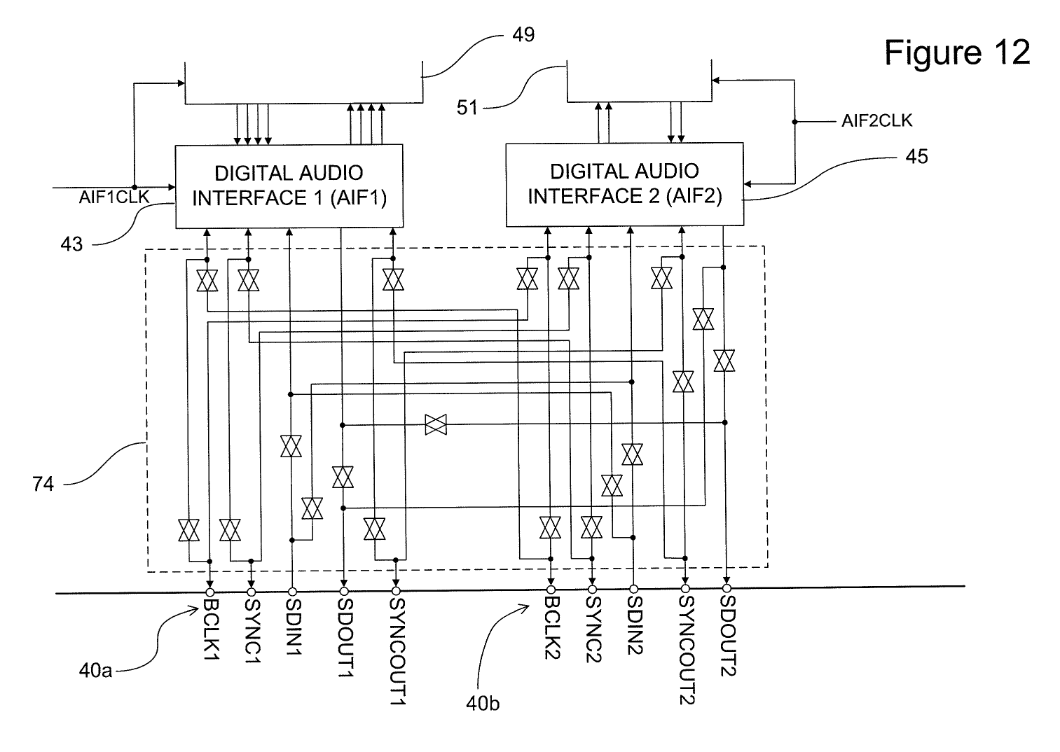

FIG. 12 shows the digital audio interface circuits and the associated interface connectors, together with the signal routing system between them, in the audio hub integrated circuit, in a functional equivalent of FIG. 8, depicting the routing system using different circuit elements.

FIG. 1 shows a mobile telephone 1, which incorporates an integrated circuit embodying the present invention. The mobile telephone 1 has a screen 3 and a keypad 5. It has in inbuilt speaker 7 and a main inbuilt microphone 9, which are both analog transducers, together with four digital microphones 11 that allow simultaneous multiple audio streams to be received for use, for example, by a noise cancellation facility in the mobile telephone 1.

As shown in FIG. 1, the mobile telephone 1 may be connected by wire to a headset comprising a stereo pair of earpieces 13 and a microphone 15. Alternatively, the mobile telephone 1 may communicate with a wireless headset 17, comprising earpieces 19 and a microphone 21, for example using the Bluetooth (trade mark) wireless communication system. Separately or simultaneously with the communication with a headset, the mobile telephone 1 may be connected to an external audio system 23. The external audio system 23 comprises stereo speakers 25. Additionally, associated circuitry in the external audio system 23 may include volume and other audio controls that operate independently of the mobile telephone 1 to affect the sound provided by the speakers 25. At different times, the external audio system 23 may be a tabletop stereo sound system or may be an in-car audio system. The circuitry 27 of the external audio system 23 may also include a radio receiver, or other audio source, which may provide an audio input to the mobile telephone 1, for example so that the radio or other audio can be played back through the earpieces 13, 19 of a headset.

Depending on the circumstances, the mobile telephone 1 may output three separate audio streams simultaneously, respectively to the earpieces 13, 19 of the wired or wireless headset, to the in-built speaker 7 and to the speakers 25 of the external audio system 23. For example, if the mobile telephone 1 is fitted into a docking station in a car and is equipped with a GPS satellite navigation system, the mobile telephone may simultaneously (a) handle a mobile telephone conversation via the wired or wireless headset, (b) provide stereo music from its memory to the external audio system 23, which in this case is the car's in-built audio system, and (c) provide tones for confirmation of button presses and provide satellite navigation instructions via the in-built speaker 7. Consequently, the system in the mobile telephone 1 for interacting with audio transducers has to handle simultaneously three separate audio output data streams and at least one audio input data stream (from the headset microphone 15, 21 as part of the telephone conversation). Although in theory the separate audio output streams could be mixed and be provided through a single set of output transducers (speakers 25, 7 or earpieces 13, 19), the user's experience is improved if the three audio streams are provided through different transducers, particularly as this makes it much easier for the user to separate the three audio streams psychologically and respond to each stream in the appropriate manner.

FIG. 2 shows the main components in the audio handling system within the mobile telephone 1. Communication with the cellular telephone network 29 is handled by a baseband processor 31 (sometimes referred to as a communications processor). An applications processor 33 handles processes in which audio data is reproduced from or stored into a memory 35, and other processes in which audio data is generated internally within the telephone 1. For example, the applications processor 33 will handle the reproduction of stereo music stored digitally in the memory 35, will handle recording of telephone conversations and other audio data into the memory 35, and will also handle the generation of satellite navigation commands and the generation of tones to confirm the pressing of any button on the keypad 5. A wireless transceiver 37 (sometimes also called a wireless codec) handles communication using the Bluetooth (trade mark) protocol, or communication using another similar short-range wireless communication protocol, with the wireless headset 17.

The baseband processor 31, the applications processor 33 and the wireless transceiver 37 all send audio data to, and receive audio data from, an audio hub 39, which is an integrated circuit embodying the present invention. The audio signals between these external circuits 31, 33, 37 and the audio hub 39 are all digital, and some of them may be stereo (i.e. comprise a left data stream and a right data stream). Additionally, at least in the case of communication with the applications processor 33, further data streams may be time division multiplexed into the audio signals, e.g. to enable the applications processor 33 to provide stereo music and also other audio such as key press confirmation tones simultaneously. The baseband processor 31, the applications processor 33 and the wireless transceiver 37 send audio data to, and receive audio data from, the audio hub 39 over respective serial audio data links 38a, 38b, 38c. The data links are connected to respective sets of connectors (pins, pads etc.) 40a, 40b, 40c of the audio hub 39.

The audio hub 39 provides audio signals to, and receives audio signals from, the built-in audio transducers (speaker 1 and microphones 9, 11) and the transducers of external devices connected by wire (earpieces 13 and microphone 15 of the wired headset and speakers 25 of the audio system 23). Depending on the nature of each individual transducer, the signals may be either analog or digital. Additionally, the audio hub may receive stereo audio input signals from the radio receiver 41 in the external audio system 23. Again, depending on the nature of the connection to the external audio system 23, these signals may be digital or analog. Furthermore, via its connection to the wireless transceiver 37, the audio hub 39 handles signals to and from the transducers in the wireless headset 17 (the earpieces 19 and microphone 21).

FIG. 3 illustrates the main components of the digital audio processing parts of the audio hub 39. The audio hub 39 will also include various analog circuits, not illustrated in FIG. 3, for handling received analog inputs before they are converted to digital and for handling analog outputs after conversion from digital. For example, these may include analog mixers and, in the case of outputs, suitable line driver circuits appropriate for the characteristics of the analog speakers or earphones connected to the audio hub 39.

In FIG. 3, digital audio signals received from, and sent to, external circuits such as the baseband processor 31, the applications processor 33 and the wireless transceiver 37 are received into the integrated circuit of the audio hub 39 and are output from it through digital audio interface circuits 43, 45, which receive signals from and provide signals to the sets of interface connectors 40a, 40b, 40c shown in FIG. 2. The digital audio interface circuits 43, 45 operate in accordance with control settings that correspond to the data transfer protocol of the data link 38a, 38b, 38c over which the respective interface circuit communicates with an external circuit, and operate to convert the digital audio data between the data format used within the audio hub 39 (which may for example be 16-bit parallel with multiple channels carried in parallel on separate conductors) and the audio data format used on the data link (which is serial data with multiple channels time-division multiplexed onto a single conductor).

On the side of the digital audio interface circuits 43, 45 towards the interior of the audio hub 39, the digital signal channels are grouped together in pairs, each pair of channels being regarded as comprising a left and a right stereo audio channel, even though in practice the signals carried on the two channels of a pair may in some circumstances not in fact be corresponding left and right stereo audio data. On the side of the digital audio interface circuits 43, 45 towards the interior of the audio hub 39, each pair of channels passes through a respective switching and mixing block 47, which can be configured to pass the signals unaltered, or to exchange the digital audio data between the left and right channels of a pair, or to mix the channels so as to output mono audio data corresponding to the input left and right stereo audio data.

On the side of the switching and mixing blocks 47 towards the interior of the audio hub 39, the digital audio data channels pass through audio signal conditioning blocks 49, 51. A separate respective audio signal conditioning block is provided for the audio data channels associated with the different respective digital audio interface circuits. In each audio signal conditioning block 49, 51, various signal conditioning circuits are available, such as a gain adjustment (volume adjustment) circuits 53, dynamic range control circuits 55, high-pass filters 57 for output channels, and equalisation or 3D stereo enhancement circuits 59 for input channels.

The first digital audio interface circuit 43, and the first audio signal conditioning block 49 which conditions the audio channels passing to and from the first digital audio interface circuit 43, both operate in accordance with the same clock signals, indicated as AIF1CLK in FIG. 3. Similarly, the second digital audio interface circuit 45, and the second audio signal conditioning block 51, both operate in accordance with the same clock signals as each other, indicated in FIG. 3 as AIF2CLK. Each set of clock signals is derived, at least in part, from the bit clock of the respective data link 38a, 38b, 38c, to ensure that the operation of each digital audio interface circuit 43, 45 and the circuits in its respective audio signal conditioning block 49, 51 are synchronised with the data signals being handled by the circuits. The two sets of clock signals AIF1CLK and AIF2CLK can be wholly independent of each other, so that the first digital audio interface circuit 43 can be in communication with a first external circuit and the second digital audio interface circuit 45 can be in communication with a second external circuit, and the first and second external circuits can have entirely separate clocks from each other and do not have to be synchronised with each other. In this way, the audio hub 39 can communicate simultaneously with two external circuits that are not synchronised with each other.

The main mixing and routing of digital audio signals within the audio hub 39 is carried out in a digital core 61, which operates in accordance with a system clock SYSCLK. The system clock SYSCLK will be synchronised with one or the other of the digital audio interface clocks AIF1CLK and AIF2CLK. However, if the two digital audio interface clocks are not synchronised with each other, this means that the digital audio signals in some of the interface data channels are not synchronised with the system clock SYSCLK. Additionally, the data communicated with different external circuits may have different data sample rates, whereas if inputs received from the two external circuits are to be mixed within the digital core 61 they need to have the same sample rate and if signals from a common digital source (or from a common analog-to-digital converter) are to be output simultaneously to both external circuits then the outputs from the digital core 61 to the two digital audio interface circuits 43, 45 will inevitably have the same sample rate. In order to handle the possible sample rate differences and possible lack of clock synchronisation between the digital core 61 and one of the digital audio interface circuits 43, 45, a sample rate conversion block 63 is provided between the digital core 61 and the first and second audio signal conditioning blocks 49, 51. The sample rate conversion block 63 contains asynchronous digital sample rate conversion circuits that can be switched into whichever digital audio channels are required in order to cope with the sample rate differences and clock asynchronisation.

The digital core 61 is arranged to interface with the various audio transducers that are built in to the mobile telephone 1 or that may be connected to it, via analog processing circuits in the case of analog transducers. Accordingly, it has four digital input lines 65, for receiving inputs from the digital microphones 11, and two analog-to-digital converters 67 (nominally allocated to left and right channels) for receiving analog inputs from the main microphone 9 in the mobile telephone 1 or the microphone 15 of the wired headset, or for receiving a stereo analog audio input from an external source such as the radio receiver 41 of the external audio system 23. The digital core 61 is not designed for providing any signals to digital output transducers, but does have four digital-to-analog converters 71, nominally allocated to left and right stereo channels for two separate stereo audio streams, to enable it to drive the built-in speaker 71 of the mobile telephone 1, the earpieces 13 of the wired headset, or the speakers 25 of the external audio system 23.

The digital audio input channels from the first and second digital audio interface circuits 43, 45 are each connectable to a respective input of each of four output mixers 71, each output mixer 71 being associated with a respective digital-to-analog converter 69. Accordingly, any of the input channels from the digital audio interface circuits 43, 45 can be connected to any of the digital-to-analog converters 69 for output to an audio transducer, and any of the input channels may be mixed together before being provided to a respective digital-to-analog converter 69. Additionally, the outputs from two of the output mixers 71 provide the digital data for the output channels for the second digital audio interface circuit 45. The audio transducer inputs to the digital core 61 are connected to provide digital audio data to the input channels of the first digital audio interface circuit 43. Additionally, a connection shown at the top of FIG. 3 connects signals from the audio input transducers (microphones etc.) to further inputs for the output mixers 71. This provides a path for digital sidetone, in which the user's speech input to a microphone during a telephone conversation is mixed at low volume into the audio signal delivered to the user's ears. This also provides the path by which signals from the input transducers can be output, via appropriate ones of the output mixers 71, to the output channels of the second digital audio interface circuit 45. A further set of mixers 73 allows signals from the input channels of the second digital audio interface circuit 45 to be mixed into the signals from the input transducers before the signals are output to the output channels of the first digital audio interface circuit 43.

Because each of the output channels for both digital audio interface circuits 43, 45 is connected to the output of a respective one of the mixers 71, 73, it is possible for any of the output channels to receive a combination of audio input received through one of the transducers with a further audio input received through the other of the digital audio interface circuits 43, 45. For example, during a telephone conversation the user's speech, received by the digital core 61 via one of the analog-to-digital converters 67 from the main microphone 9 of the digital telephone 1 or from the microphone 15 of the wired headset, may be mixed with the incoming speech from the remote end of the telephone conversation, received by the digital core 61 from the baseband processor 31 via the second digital audio interfaces circuits 45, and the mixed speech may be output through the first digital audio interface circuit 43 to the applications processor 33 so that the telephone conversation can be recorded in the memory 35. Simultaneously, the applications processor 33 may reproduce music from the memory 35 and provide that through the first digital audio interface circuit 43 to the digital core 61, where it is mixed into the local speech received through one of the analog-to-digital converters 67, and the mixed signal can then be provided through the second digital audio interface circuit 45 to the baseband processor 31 so that the person at the other end of the telephone conversation hears the voice of the user of the mobile telephone 1 mixed into the music. Simultaneously with both of those audio streams, the music provided from the applications processor 33 may also be routed so as to be mixed separately with the speech received from the remote end of the telephone conversation and this mixed signal may be output through the upper pair of digital-to-analog converters 69 in FIG. 3 (to provide the music in stereo) to the earpieces 13 of the wired headset.

A further consequence of the output from mixers 71, 73 to the output channels of the digital audio interface circuits 43, 45 is that signals received from the input channels of one of the digital audio interface circuits 43, 45 may be output, without being mixed with any other signal, to output channels of the other of the digital audio interface circuits 43, 45. Because of the effect of the sample rate conversion block 63, this enables the audio hub 39 to route digital audio signals from one external circuit to another, for example from the baseband processor 31 to the applications processor 33, without the need for the two external circuits to have synchronised clocks.

FIG. 3 shows the digital audio interface circuits 43, 45, but does not show the associated sets of connectors 40a, 40b, 40c by which the serial data links 38a, 38b, 38c to external circuits are coupled to the digital interface circuits. These are shown in FIG. 4 (which omits the switching and mixing blocks 47 in order to simplify the drawing).

As shown in FIG. 4, the audio hub 39 has three sets of interface connectors 40a, 40b, 40c, so that it can be physically connected to three audio data buses or other audio data links 38a, 38b, 38c. As shown in FIG. 4, a signal routing system 74 (depicted in FIG. 4 by multiplexers and associated wiring) enables the three sets of interface connectors 40a, 40b, 40c to share the two digital audio interface circuits 43, 45. In FIG. 4, the first set of interface connectors 40a is coupled to the first digital audio interface circuit 43. The second set of interface connectors 40b is coupled to the second digital audio interface circuit 45. The third set of interface connectors 40c can be coupled selectively either to the first digital audio interface circuit 43 or to the second digital audio interface circuit 45. This enables the audio hub 39 to be connected so as to interface with three external circuits, that is to say the baseband processor 31, the applications processor 33 and the wireless transceiver 37 of FIG. 2, while only having two digital audio interface circuits 43, 45, thereby saving cost and complexity in the construction of the audio hub 39.

Additionally, the second and third sets of interface connectors 40b, 40c may be coupled to each other by a route that does not include any interface circuit, rather than be coupled to one of the digital audio interface circuits. This ability to couple the second and third sets of interface connectors to each other enables audio data from one external circuit to be routed to another external circuit without the audio data needing to pass through the digital audio interface circuits 43, 45, the audio signal conditioning blocks 49, 51 and the digital core 61. This can provide various advantages such as reduced power consumption in the audio hub 39 and an increase in the number of audio paths through the audio hub 39 available for other signals. The connections between the interface connectors and the digital audio interface circuits will now be described in further detail.

The first and second sets of interface connectors 40a, 40b each consist of five connectors, as follows. Connector SDIN carries serial data input to the audio hub 39. Connector SDOUT carries audio data output from the audio hub 39. The data carried on SDIN and SDOUT is serial, and at least two channels can be time division multiplexed into each data stream, to permit left and right stereo audio to be transmitted (some data transfer protocols also permit more than two data channels to be multiplexed into each data stream). Connector BCLK carries the bit clock, which determines the timing of all other signals on the data link 38a, 38b connected to the connectors. That is to say, the signals on all four other connectors of the set must be synchronised to the clock signal on BCLK. This connector is bi-directional, that is to say it may be either an input or an output. If the audio hub is operating in master mode with respect to this data link 38a, 38b, clock BCLK is generated within the audio hub 39 and is output by it onto the corresponding connector, and the other circuit with which the audio hub communicates over the data link is required to operate in slave mode, receiving the clock signal BCLK from the audio hub 39 and controlling the timing of its interface circuits in response. If the audio hub 39 is operating in slave mode with respect to this data link 38, it will receive the bit clock signal via the BCLK connector and the relevant digital audio interface circuit 43, 45 will time its operations accordingly. Connector SYNC carries a synchronisation signal. This is generated from and synchronised with the bit clock signal BCLK. Signal SYNC is used to signal when the bit stream of the input audio data on SDIN changes from one data packet, data frame or data channel to another. The precise use of this synchronisation signal will vary depending on the data transfer protocol being used. For example, in the I²S protocol the serial data stream consists of data words for a left channel alternating with data words for a right channel, and all data bits belong to one channel or the other, and the SYNC signal acts as the word select signal, indicating in accordance with the I²S protocol when the word for one channel ends and the next word for the other channels begins. However, in the PCM protocol, a greater number of channels can be time division multiplexed into the serial audio data, and the data is sent in a succession of frames each of which contains one data word for each channel in turn. In this case, the SYNC connector carries the frame sync signal, the rising edge of which indicates the beginning of a new frame.

The other circuit, with which the audio hub 39 communicates, will always synchronise the data words or frames provided to the SDIN connector with the synchronisation signal SYNC. The audio hub 39 can use the same synchronisation signal to time the data words or frames output on the SDOUT connector, or alternatively the output data can have a different frame or word timing from the input data, in which case the output data frame or word timing is indicated by a synchronisation signal on connector SYNCOUT. Both the connector SYNC and the connector SYNCOUT may be inputs or outputs, so that when the audio hub 39 is communicating with one of the other circuits 31, 33, 37, the audio hub 39 can determine the word or frame timing for one of the data streams while the other circuit determines the word or frame timing for the other data stream. However, whichever circuit generates the signal SYNC or the signal SYNCOUT, it must be synchronised with the bit clock BCLK.

As shown in FIG. 4, the third set of interface connectors 40c does not include any SYNCOUT connector, so that the possibility of different frame or word synchronisation for input and output data is not available for this data link. However, such an interface connector could be provided if desired. Additionally, the arrangement of multiplexers for the timing connectors BCLK3 and SYNC3 is such that both of these connectors can only be outputs, so that the audio hub 39 always operates in master mode when communicating over the third data link 38c. It should be noted that the independent operation of the two digital audio interface circuits 43, 45 means that one of these interface circuits can operate as a BCLK master while the other operates as a BCLK slave, so that the fact that data communication is taking place via the third set of interface connectors 40c in master mode does not prevent simultaneous data communication with another external circuit using the first or second set of interface connectors 40a, 40b in slave mode. Additionally, if desired the wiring and multiplex arrangements for the BCLK and SYNC timing signals could be modified to permit BCLK3 and SYNC3 to be either input or output, allowing communication via the third set of interface connectors 40c also to be conducted in master or slave mode as desired. A multiplexer and wiring arrangement allowing a timing signal connector to be used either as an input or as an output as desired, and to be coupled selectively to either interface circuit 43, 45, is shown for example in FIG. 8.

In the present embodiment, the applications processor 33 is connected to the first set of interface connectors 40a, the baseband processor 31 is connected to the second set of interface connectors 40b and the wireless transceiver 37 is connected to the third set of interface connectors 40c. Accordingly, data communication between the audio hub 39 and the applications processor 33 will always take place via the first digital audio interface circuit 43 and data communication between the audio hub 39 and the baseband processor 31 will always take place via the second digital audio interface circuit 45. Communication with the wireless transceiver 37 may take place via either digital audio interface circuit. As can be seen from FIG. 3, the first digital audio interface circuit 43 can handle four data input channels and four data output channels, whereas the second digital audio interface circuit 45 con only handle two audio input channels and two audio output channels. Since the audio data handled by the baseband processor 31 will be the voice channels of a telephone conversation, two input channels and two output channels should be sufficient for all communications with it. Similarly, the wireless transceiver 37 communicates with the wireless headset 17, and the limited number of transducers on the headset implies that two input channels and two output channels will be sufficient. However, the applications processor 33 may have to handle multiple audio data streams simultaneously, such as outputting stereo music (requiring two channels) simultaneously with keypad confirmation tones and/or satellite navigation voice instructions, and so four output channels may be required. Additionally, the four digital microphones 11 are used to provide four parallel input data streams to the applications processor 33 for use by a noise reduction algorithm which may be used both to improve the reliability of software recognition of voice commands and to reduce background noise in the local speech signal in a telephone conversation if the mobile telephone 1 is used in a noisy environment. Accordingly, the applications processor 33 may also require four input data channels.

The signal routing system 74 between the sets of interface connectors 40a, 40b, 40c on the one hand and the first and second digital audio interface circuits 43, 45 on the other hand permit considerable flexibility in routing of audio signals and the performance of the audio hub 93 and the mobile telephone 1 as a whole.

For example, if the wireless transceiver 37 can be operated synchronously with the baseband processor 31, the user can conduct a telephone conversation using the wireless headset 17, and the local telephone audio signal provided by the wireless transceiver 37 from the wireless headset 17 to connector SDIN3 in the third set of connectors 40c can be routed directly to connector SDOUT2 in the second set of connectors 40b so as to be supplied to the baseband processor 31. At the same time, the remote telephone audio signal provided by the baseband processor 31 from the telephone network to connector SDIN2 in the second set of connectors 40b can be routed directly to connector SDOUT3 in the third set of connectors 40c so as to be supplied to the wireless transceiver 37. In this way the telephone conversation audio signals are routed between the baseband processor 31 and the wireless transceiver 37 without passing through the digital audio interface circuits 43, 45 at all, and effectively a direct connection is established between the wireless transceiver 37 and the baseband processor 31 even though these two circuits are not directly connected within the mobile telephone 1. If desired, the applications processor 33 can simultaneously be communicating with the digital core 61 of the audio hub 39 via the first set of interface connectors 40a and the first digital audio interface circuit 43, for example to output stereo music via two of the digital-to-analog converters 69 to speakers 25 of an external audio system 23 within a car, and also outputting satellite navigation messages via a third digital-to-analog converter 69 to the mobile telephone's in-built speaker 7.

In an alternative example it is desired not to synchronise the data transfer of the wireless transceiver 37 with the baseband processor 31 (for example because synchronisation creates problems with audio quality or consumes excessive power). In this case, signals to and from the wireless transceiver 37 at connectors SDOUT3 and SDIN3 of the third set 40c are routed through the first digital audio interface circuit 43, while signals to and from the baseband processor 31 at connectors SDOUT2 and SDIN2 of the second set 40b are routed through the second digital audio interface circuit 45. The signals received through each interface circuit are routed out through the other interface circuit by appropriate control within the digital core 61 of the audio hub 39. With this arrangement, the operation of the sample rate conversion block 63 allows the two digital audio interface circuits 43, 45 to operate asynchronously with respect to each other and therefore allows the baseband processor 31 and the wireless transceiver 37 to operate asynchronously with respect to each other.

In the preceding example, the third set of interface connectors 40c was coupled through the routing system 74 to the first digital audio interface circuit 43. Under other circumstances, the third set of interface connectors 40c may be coupled through the routing system 74 to the second digital audio interface circuit 45. For example, if the applications processor 33 is connected to the Internet, either via a wired connection from the mobile telephone 1 to a computer or an Internet router or via an additional wireless transceiver and a wireless Internet connection, the mobile telephone 1 can be used to make a telephone call using voice-over-Internet protocol (VoIP) instead of using the cellular mobile telephone network. In this case, the baseband processor 31 does not need to be connected to the audio hub 39, since the cellular telephone network is not being used. If the user makes the telephone call using the wireless headset 17, the wireless transceiver 37 can be coupled through the third set of interface connectors 40c to the second digital audio interface circuit 45, while the applications processor 33 is coupled through the first set of interface connectors 40a to the first digital audio interface circuit 43, enabling the voice signals for the VoIP telephone call to be coupled between the applications processor 33 and the wireless transceiver 37 via the digital core 61 of the audio hub 39. A similar signal routing arrangement, with the applications processor 33 communicating with the digital core 61 via the first digital audio interface circuit 43 and the wireless transceiver 37 communicating with the digital core 61 via the second digital audio interface circuit 45, can be used to allow the playback of stereo music, read out from the memory 35, from the applications processor 33 to the earpieces 19 of the wireless headset 17.

In the first example given above, both the input audio and the output audio for the wireless transceiver 37 were routed directly between the second and third sets of interface connectors 40b 40c, without passing through either digital audio interface circuit 43, 45, whereas in the remaining examples both the input audio data and the output audio data for the wireless transceiver 37 is routed through one of the digital audio interface circuits. However, it is not necessary for the input audio data stream and the output audio data stream to be routed in the same manner. For example, an audio stream originating from the microphone 21 of the wireless headset 17, and provided by the wireless transceiver 37 to connector SDIN3 of the third set of interface connectors 40c may be routed directly to connector SDOUT2 of the second set of interface connectors 40b, so as to provide the local voice data directly from the wireless transceiver 37 to the baseband processor 31 without signals passing through the digital core 61 of the audio hub 39. On the other hand, the remote voice audio received from the baseband processor 31 at connector SDIN2 of the second set of interface connectors 40b may be routed through the second digital audio interface circuit 45 into the digital core 61 of the audio hub 39, to enable it to be mixed with other audio signals received from the applications processor 33 via the first digital audio interface circuit 43, such as reproduced music or satellite navigation instructions. The mixed audio signal is then routed back out through the second digital audio interface circuit 45 and to connector SDOUT3 of the third set of interface connectors 40c for transmission to the wireless transceiver 37 and the earpieces 19 of the wireless headset 17. Accordingly, in this case the audio data received from the wireless transceiver 37 on connector SDIN3 is routed directly to connector SDOUT2, whereas the output data stream to the wireless transceiver 37 via connector SDOUT3 is provided from the second digital audio interface circuit 45. It should be noted that this operation not only requires that the wireless transceiver 37 and the baseband processor 31 communicate synchronously, but that the second digital audio interface circuit 45 of the audio hub 39 is also properly synchronised with both external circuits. Therefore the same BCLK signal should be used by the second digital audio interface circuit 45 and both external circuits 31, 37.

The routing system 74 for coupling signals between digital audio interface circuits and interface connectors shown in FIG. 4 is merely one embodiment. Other arrangements could be provided in alternative embodiments, if desired, providing different options for coupling sets of interface connectors to digital audio interface circuits or to each other. In an integrated circuit having two digital audio interface circuits 43, 45 and three sets of interface connectors 40a, 40b, 40c, the full set of possible signal routes that could be provided for the sets of interface connectors is shown schematically in FIG. 5, where the broken lines indicate the different connections that may be made from each group of interface connectors. In any particular embodiment, the routing system 74 may be constructed so as to enable any or all of these signal routes to be provided. Additionally, embodiments can be provided having a different number of digital audio interface circuits and a different number of sets of interface connectors, in place of the two digital audio interface circuits and three sets of connectors shown in FIGS. 4 and 5. Embodiments are possible in which there are the same number of digital audio interface circuits as there are sets of interface connectors, but provision is made for switching at least some signals for at least one set of interface connectors from a route via one digital audio interface circuit to a route via another digital audio interface circuit, and/or provision is made to route signals from one or more connectors of one set of interface connectors to connectors of another set of interface connectors. Additionally, where there are more sets of interface connectors than there are digital audio interface circuits, there may be more than one additional set of interface connectors, rather than just one additional set as shown in FIGS. 4 and 5. Some specific examples of alternative embodiments are shown in FIGS. 6 to 11.

FIG. 6 shows an embodiment in which the arrangement of digital audio interface circuits 43, 45 and sets of interface connectors 40a, 40b, 40c is similar to the arrangement shown in FIG. 4. However, in this embodiment the signal routing system 74 between the digital audio interface circuits and the interface connectors is additionally able to route signals directly between the first set of connectors 40a and the third set of connectors 40c without passing through any digital audio interface circuit. Accordingly, in this embodiment the third set of interface connectors 40c can be selectively coupled to either of the digital audio interface circuits 43, 45 and to either of the other sets of interface connectors 40a, 40b, providing full flexibility for the routing of signals passing through the third set of interface connectors.

FIG. 7 shows an embodiment in which, in addition to the increased flexibility of routing for signals passing through the third set of interface connectors 40c, there is additional flexibility for the routing of signals passing through the first and second sets of interface connectors 40a, 40b. In FIG. 7, all sets of interface connectors 40a, 40b, 40c may be coupled to either of the digital audio interface circuits 43, 45. That is to say, as compared with FIG. 6, it is possible to route signals to and from the first set of interface connectors 40a through first digital audio interface circuit 43 or through the second digital audio interface circuit 45, and this is also the case for signals through the second set of interface connectors 40b. Accordingly the only routing possibility not provided in the embodiment of FIG. 7 is direct routing of signals between the first set of interface connectors 40a and the second set of interface connectors 40b without passing through any digital audio interface circuit (although such a facility could be added if desired). Additionally, in the embodiment of FIG. 7 the arrangement of multiplexers and wiring illustrated for the routing system 74 is such that the bit clock BCLK, the synchronisation signal SYNC and the output synchronisation signal SYNCOUT can be provided either as an input or as an output from either digital audio interface circuit 43, 45 to either one of the first and second sets of interface connectors 40a, 40b. Accordingly, whether signals for the first set of interface connectors 40a are routed through the first digital audio interface circuit 43 or through the second digital audio interface circuit 45, the interface circuit can be operated in master or slave mode, and the same is true for the signals passing through the second set of interface connectors 40b. As with the embodiments of FIGS. 4 and 6, the timing signal connectors in the third set of interface connectors 40c have not been provided with this possibility, so that the third set of interface connectors 40c can only be used in master mode.

FIG. 8 illustrates an embodiment in which there is the same number of sets of interface connectors 40a, 40b as there are digital audio interface circuits 43, 45, that is to say, there are two of each in this embodiment. In this embodiment, no provision is made for direct connection of one set of interface connectors 40a, 40b to the other set of interface connectors 40b, 40a without signals passing through the digital audio interface circuits 43, 45. However, the signal routing system 74 makes full provision for either set of interface connectors 40a, 40b to be coupled to either of the digital audio interface circuits 43 45, with each set of interface connectors being operable in master or slave mode with whichever digital audio interface circuit 43, 45 it is coupled to.

By contrast, FIG. 9 shows an embodiment in which there are two digital audio interface circuits 43, 45 and two sets of interface connectors 40a, 40b, and the first digital audio interface circuit 43 can only communicate with the first set of interface connectors 40a while the second digital audio interface circuit 45 can only communicate with the second set of interface connectors 40b, but signal routing is possible to enable signals to pass between the two sets of interface connectors 40a, 40b without passing through the digital audio interface circuits. As will be understood by those skilled in the art, the features of the embodiments of FIGS. 8 and 9 may be combined, so as to provide an arrangement in which signals can be routed directly from one set of interface connectors to the other as in FIG. 9 and additionally signals passing through either or both sets of interface connectors may be routed selectively through either of the digital audio interface circuits, as in the embodiment of FIG. 8.

FIG. 10 shows an embodiment in which there are two digital audio interface circuits 43, 45 and four sets of interface connectors 40a, 40b, 40c, 40d. In this case, signals passing through the first set of interface connectors 40a can be routed through the first digital audio interface circuit 43 but not the second digital audio interface circuit 45, and signals passing through the second set of interface connectors 40b can be routed through the second digital audio interface circuit 45 but not the first digital audio interface circuit 43. Signals passing through the third set of interface connectors 40c can be routed through either of the digital audio interface circuits 43, 45 and can also be routed directly through either of the first set of interface connectors 40a and the second set of interface connectors 40b without passing through any digital audio interface circuit, but cannot be routed directly through the fourth set of interface connectors 40b. Signals passing through the fourth set of interface connectors 40d can be routed through either of the digital audio interface circuits 43, 45 and can also be routed directly through the first set of interface connectors 40a without passing through any digital audio interface circuit, but cannot be routed directly through the second or third sets of interface connectors 40b, 40c. As will be understood by those skilled in the art, this is merely one particular arrangement out of many possible arrangements for the signal routing system between two digital audio interface circuits and four sets of interface connectors.

FIG. 11 shows an embodiment having three digital audio interface circuits 43, 45, 75 and four sets of interface connectors 40a, 40b, 40c, 40d. In this case, signals passing through the first set of interface connectors 40a, signals passing through the second set of interface connectors 40b and signals passing through the fourth set of interface connectors 40d can only be routed through one respective digital audio interface circuit 43, 45, 75 and cannot be routed to any other digital audio interface circuit, while signals passing through the third set of interface connectors 40c can be routed through any of the three digital audio interface circuits 43, 45, 75. Additionally, provision is made for a direct connection between the third set of interface connectors 40c and the second set of interface connectors 40b and also between the third set of interface connectors 40c and the first set of interface connectors 40a, but not between any other pairs of sets of interface connectors. Additionally, in this embodiment the fourth set of interface connectors 40d includes a output synchronisation signal SYNCOUT connector, and all three timing signal connectors of this set 40d can carry signals in either direction to and from the respective digital audio interface circuit 75, so that the data link connected to this set of connectors 40d can be operated in full master or slave mode with separate frame or word synchronisation for input data and output data, as is also possible with the first and second sets of interface connectors 40a 40b. The third set of interface connectors 40c remains operable only in master mode and cannot support different frame or word synchronisation for input data and output data.

FIGS. 4 and 6 to 11 illustrate various configurations for the routing system 74 in which the elements that control the routes followed by signals are depicted as multiplexers of the type which permit signals to pass through only in the forward direction and not in the reverse direction. However, it should be understood that the precise nature of the elements used, and the layout of the routing system 74, are not important provided that the required routing logic is provided. Accordingly, FIG. 12 shows the routing system 74 of FIG. 8 redrawn so as to use bidirectional transmission gates as the elements that control the routes followed by signals. Although the layout is different from FIG. 8, the routing logic is the same. In practice any appropriate switching or routing elements or arrangements may be used provided that the correct overall routing abilities for the routing system are provided.

When any of the embodiments are operated so that audio data signals received via the SDIN terminal of one set of connectors 40a, 40b, 40c, 40d are routed to the SDOUT terminal of another set of connectors without passing through any digital audio interface circuit on its path between the SDIN and SDOUT terminals (such as when data is passed directly between the wireless transceiver 37 and the baseband processor 31), the two sets of terminals must carry the same clock signals on their BCLK terminals, in order to ensure that the external circuit providing the data to the SDIN terminal and the external circuit receiving the data from the SDOUT terminal handle the data with proper bit-synchronisation. This can be done by arranging for one external circuit to communicate in master mode, generating and outputting the BCLK signal, and the other external circuit to communicate in slave mode, controlling its operations in accordance with the timing of the received BCLK signal. Alternatively, both external circuits may communicate in slave mode, and the bit clock BCLK may be provided by the audio hub 39 itself. The audio hub may provide the BCLK signal even if it does not receive the SDIN signal from either of the sets of connectors involved nor provide the SDOUT signal to either of the sets of connectors. However, the BCLK signal will normally only be provided from the audio hub 39 if one of the digital audio interface circuits 43, 45, 75 provides the SDOUT signal to, or receives the SDIN signal from, one of the sets of connectors 40a, 40b, 40c, 40d between which audio data is being directly communicated.

The present embodiments merely illustrate some of the possible arrangements of digital audio interface circuits, sets of interface connectors and the routing system between them, and it will be understood by those skilled in the art that many other alternatives are possible. The provision of the signal routing system 74 provides considerable flexibility and the possibility of cost saving in the design of the audio hub 39. As will be clear from the embodiments, it is possible for the audio hub 39 to support more sets of interface connectors 40, and therefore more audio data links 38, than the number of digital audio interface circuits provided in it. Additionally, the audio hub 39 may have two or more digital audio interface circuits but these circuits are not necessarily identical with each other and may have different capabilities. As is illustrated in the embodiments, one digital audio interface circuit may be able to handle more audio channels than another. Other differences are possible, such as a difference in the range of audio data transfer protocols that can be supported by any particular digital audio interface circuit. Additionally or alternatively, a difference may be provided not in the digital audio interface circuit itself but in associated circuitry such as the audio signal conditioning blocks. For example, in the embodiment of FIGS. 3 and 4 the audio signal conditioning block 49 for the first digital audio interface circuit 43 includes the provision of high pass filters in the output channels whereas this is not included in the corresponding audio signal conditioning block 51 for the second digital audio interface circuit 45. However, the flexibility provided by the routing system 74 between the sets of interface connectors and the digital audio interface circuits can for example enable the audio hub to be constructed with only one digital audio interface circuit having a particular capability, but signal communication with different external circuits can, at different times, benefit from the particular capability provided only in one of the digital audio interface circuits owing to the ability to change the route followed by the signals as they pass between the interface connectors and the audio interface circuits. This enables the other digital audio interface circuits to be simpler, or to have alternative capabilities, so as to provide the audio hub 37 with a lower cost of manufacture or a greater range of capabilities than would otherwise be possible.

Additionally, the ability to route signals directly from one of the sets of interface connectors 40 to another set of interface connectors 40 enables signals to pass directly from one external device to another without passing through the digital audio interface circuits, provided that the two external circuits are compatible for direct signal transfer and the audio hub 39 is not required to provide a function such as changing signal synchronisation. This enables signals to be transferred between external circuits that have no direct connection within the mobile telephone or other device in which the audio hub is used, without the signals passing through the main digital core of the audio hub. This may be advantageous both to save power consumption within the audio hub and to avoid signals occupying digital signal paths within the digital core of the audio hub when no processing or mixing of those digital signals is required within the audio hub. This allows the audio hub 39 to provide the maximum flexibility in handling multiple audio signals independently, without the cost and complexity of providing an excessive number of independent signal paths through its digital circuits.

1. An integrated circuit for transferring audio signals between (i) audio transducers and (ii) circuits for supplying and/or receiving digital audio signals, the integrated circuit comprising:
(a) at least a first set of connectors and a second set of connectors, each set of connectors being suitable for connection to an audio data link for transferring digital audio data between the integrated circuit and one of the said circuits for supplying and/or receiving digital audio signals;
(b) at least a first digital audio interface circuit, for processing signals that pass through one of the said sets of connectors so as to convert the audio data of the signals between the data format used in the audio link to which the set of connectors is connected and a data format, different from the data format used in the audio link, usable within the integrated circuit; and
(c) a routing system connected between the said sets of connectors and the said digital audio interface circuit and arranged to select a route, from a plurality of available routes, for audio data signals passing through the said first set of connectors.

2. An integrated circuit according to claim 1 in which the said plurality of routes for audio data signals passing through the first set of connectors comprises (i) a route through the first digital audio interface circuit and (ii) a route passing through the second set of connectors without passing through any digital audio interface circuit on the route between the first and second sets of connectors.

3. An integrated circuit according to claim 1 further comprising a second digital audio interface circuit, for processing signals that pass through one of the said sets of connectors so as to convert the audio data of the signals between the data format used in the audio link to which the set of connectors is connected and a data format, different from the data format used in the audio link, usable within the integrated circuit,
and in which the said plurality of available routes for audio data signals passing through the first set of connectors comprises (i) a route through the first digital audio interface circuit and (ii) a route through the second digital audio interface circuit.

4. An integrated circuit according to claim 3 in which the routing system is capable of routing audio data signals passing through the said second set of connectors along a route through the first digital audio interface circuit.

5. An integrated circuit according to claim 3 in which the routing system is capable of routing audio data signals passing through the said second set of connectors along a route through the second digital audio interface circuit.

6. An integrated circuit according to claim 3 in which the routing system is arranged to select a route, from a plurality of available routes, for audio data signals passing through the said second set of connectors, and the said plurality of available routes for audio data signals passing through the second set of connectors comprises (i) a route through the first digital audio interface circuit and (ii) a route through the second digital audio interface circuit.

7. An integrated circuit according to claim 3 further comprising a third said set of connectors, the routing system being capable of routing audio data signals passing through the third set of connectors along at least one of: a route through the first digital audio interface circuit; and a route through the second digital audio interface circuit.

8. An integrated circuit according to claim 7 in which the said plurality of available routes for audio data signals passing through the first set of connectors comprises a route passing through the third set of connectors without passing through any digital audio interface circuit on the route between the first and third sets of connectors.

9. An integrated circuit according to claim 3 in which the range of options available for mixing, processing or routing audio data (i) within the integrated circuit after incoming digital audio data has been received by the integrated circuit via one of the sets of connectors and passed through one of the digital audio interface circuits or (ii) before outgoing audio data has passed through one of the digital audio interface circuits and has been transmitted from the integrated circuit via one of the sets of connectors (iii) or within the digital audio interface circuits, is different depending on whether the digital audio data passes through the first digital audio interface circuit or the second digital audio interface circuit.

10. An integrated circuit according to claim 3 in which the number of digital audio data channels that can be handled by the integrated circuit via the first digital audio interface circuit is different from the number of digital audio data channels that can be handled by the integrated circuit via the second digital audio interface circuit.

11. An integrated circuit according to claim 2 further comprising a second digital audio interface circuit, for processing signals that pass through one of the said sets of connectors so as to convert the audio data of the signals between the data format used in the audio link to which the set of connectors is connected and a data format, different from the data format used in the audio link, usable within the integrated circuit,
and in which the said plurality of available routes for audio data signals passing through the first set of connectors comprises (i) a route through the first digital audio interface circuit and (ii) a route through the second digital audio interface circuit.

12. An integrated circuit according to claim 11 in which the routing system is capable of routing audio data signals passing through the said second set of connectors along a route through the first digital audio interface circuit.

13. An integrated circuit according to claim 11 in which the routing system is capable of routing audio data signals passing through the said second set of connectors along a route through the second digital audio interface circuit.

14. An integrated circuit according to claim 11 in which the routing system is arranged to select a route, from a plurality of available routes, for audio data signals passing through the said second set of connectors, and the said plurality of available routes for audio data signals passing through the second set of connectors comprises (i) a route through the first digital audio interface circuit and (ii) a route through the second digital audio interface circuit.

15. An integrated circuit according to claim 11 further comprising a third said set of connectors, the routing system being capable of routing audio data signals passing through the third set of connectors along at least one of: a route through the first digital audio interface circuit; and a route through the second digital audio interface circuit.

16. An integrated circuit according to claim 15 in which the said plurality of available routes for audio data signals passing through the first set of connectors comprises a route passing through the third set of connectors without passing through any digital audio interface circuit on the route between the first and third sets of connectors.

17. An integrated circuit according to claim 1 in which there are N sets of said connectors and M sets of said digital audio interface circuits, where N and M are numbers greater than zero and N is greater than M.

18. An integrated circuit according to claim 17 in which the routing system provides, for each of the N sets of connectors, at least one route for audio data through one of the M digital audio interface circuits.

19. An integrated circuit according to claim 1 in which the routing system is capable of routing signals passing through different ones of the connectors of the first set of connectors simultaneously along different respective ones of said plurality of available routes.

20. An integrated circuit according to claim 19 in which the first set of connectors comprises a data-in connector for serial audio data received from a data link connected to the first set of connectors and a data-out connector for serial audio data provided to a data link connected to the first set of connectors, and the routing system is capable of simultaneously (i) routing signals from the data-in connector to one of the first digital audio interface circuit and the second set of connectors and routing signals to the data-out connector from the other of the first digital audio interface circuit and the second set of connectors.

21. An integrated circuit according to claim 19 in which said routing system is arranged to select a route, from the said plurality of available routes, for a timing signal passing through the said first set of connectors,
and the routing system is capable of (i) routing audio data signals passing through the first set of connectors along a route passing through the second set of connectors without passing through any digital audio interface circuit on the route between the first and second sets of connectors and simultaneously (ii) routing said timing signal passing through the first set of connectors along a path passing through the first digital audio interface circuit.

22. An integrated circuit for transferring audio signals between (i) audio transducers and (ii) circuits for supplying and/or receiving digital audio signals, the integrated circuit comprising:
(a) at least a first set of connectors and a second set of connectors, each set of connectors being suitable for connection to an audio data link for transferring digital audio data between the integrated circuit and one of the said circuits for supplying and/or receiving digital audio signals;
(b) at least a first digital audio interface circuit and a second digital audio interface circuit, each digital audio interface circuit being suitable for processing signals that pass through one of the said sets of connectors so as to convert the audio data of the signals between the data format used in the audio link to which the set of connectors is connected and a data format, different from the data format used in the audio link, usable within the integrated circuit; and
(c) a routing system connected between the said sets of connectors and the said digital audio interface circuits and arranged to select a route, from a plurality of available routes, for audio data signals passing through the said first set of connectors and to select a route, from a plurality of available routes, for audio data signals passing through the said second set of connectors,
the routing system being arranged, in a first mode, to route audio data signals passing through the first set of connectors along a route passing through the first digital interface circuit and to route audio data signals passing through the second set of connectors along a route passing through the second digital interface circuit, and being arranged, in a second mode, to route audio data signals passing through the first set of connectors along a route passing through the second digital interface circuit and to route audio data signals passing through the second set of connectors along a route passing through the first digital interface circuit.

23. An integrated circuit for transferring audio signals between (i) audio transducers and (ii) circuits for supplying and/or receiving digital audio signals, the integrated circuit comprising:
(a) at least a first set of connectors and a second set of connectors, each set of connectors being suitable for connection to an audio data link for transferring digital audio data between the integrated circuit and one of the said circuits for supplying and/or receiving digital audio signals;
(b) at least a first digital audio interface circuit, for processing signals that pass through one of the said sets of connectors so as to convert the audio data of the signals between the data format used in the audio link to which the set of connectors is connected and a data format, different from the data format used in the audio link, usable within the integrated circuit; and
(c) a routing system connected between the said sets of connectors and the said digital audio interface circuit and arranged to provide, for audio data signals passing through the said first set of connectors, a route passing through the second set of connectors without passing through any digital audio interface circuit on the route between the first and second sets of connectors.

24. An integrated circuit according to claim 23 further comprising a third said set of connectors, and in which the routing system is arranged to select a route, from a plurality of available routes, for audio data signals passing through the said first set of connectors, the said plurality of routes comprising (a) the said route passing through the second set of connectors and (b) a route passing through the third set of connectors without passing through any digital audio interface circuit on the route between the first and third sets of connectors.

25. An integrated circuit according to claim 23 in which the routing system is arranged to select a route, from a plurality of available routes, for audio data signals passing through the said first set of connectors, the said plurality of routes comprising (i) the said route passing through the second set of connectors and (ii) a route through the first digital audio interface circuit.

26. An integrated circuit according to claim 25 in which the routing system is capable of routing signals passing through different ones of the connectors of the first set of connectors simultaneously along different respective ones of said plurality of available routes.

27. An integrated circuit according to claim 26 in which the first set of connectors comprises a data-in connector for serial audio data received from a data link connected to the first set of connectors and a data-out connector for serial audio data provided to a data link connected to the first set of connectors, and the routing system is capable of simultaneously (i) routing signals from the data-in connector to one of the first digital audio interface circuit and the second set of connectors and routing signals to the data-out connector from the other of the first digital audio interface circuit and the second set of connectors.

28. An integrated circuit according to claim 26 in which said routing system is arranged to select a route, from the said plurality of available routes, for a timing signal passing through the said first set of connectors,
and the routing system is capable of (i) routing at least the audio data signals passing through the first set of connectors in one direction along a route passing through the second set of connectors without passing through any digital audio interface circuit on the route between the first and second sets of connectors and simultaneously (ii) routing said timing signal passing through the first set of connectors along a path passing through the first digital audio interface circuit.

29. A method of transferring digital audio data signals in a device comprising a plurality of audio transducers, a plurality of circuits for supplying and/or receiving digital audio signals, and an integrated circuit for transferring audio signals between the said audio transducers and the said circuits for supplying and/or receiving digital audio signals,
wherein the integrated circuit comprises:
(a) at least a first set of connectors connected to a first one of the said circuits for supplying and/or receiving digital audio signals by a first digital audio data link, and a second set of connectors connected to a second one of the said circuits for supplying and/or receiving digital audio signals by a second digital audio data link; and
(b) at least a first digital audio interface circuit, for processing signals that pass through one of the said sets of connectors so as to convert the audio data of the signals between the data format used in the audio link to which the set of connectors is connected and a data format, different from the data format used in the audio link, usable within the integrated circuit
the method comprising transferring first digital audio signals from the first said circuit for supplying and/or receiving digital audio signals to the second said circuit for supplying and/or receiving digital audio signals by:
(i) passing the first digital audio signals along the first digital audio data link to the first set of connectors of the said integrated circuit;
(ii) passing the first digital audio signals from the said first set of connectors to the second set of connectors without passing through any digital audio interface circuit on the route between the first and second sets of connectors; and
(iii) passing the first digital audio signals along the second digital audio data link to the second said circuit for supplying and/or receiving digital audio signals.

30. A method according to claim 29 in which the method further comprises transferring second digital audio signals from the second said circuit for supplying and/or receiving digital audio signals to the first said circuit for supplying and/or receiving digital audio signals, simultaneously with the said transferring of first digital audio signals from the first said circuit to the second said circuit, by:
(i) passing the second digital audio signals along the second digital audio data link to the second set of connectors of the said integrated circuit;
(ii) passing the second digital audio signals from the said second set of connectors to the first set of connectors without passing through any digital audio interface circuit on the route between the second and first sets of connectors; and
(iii) passing the second digital audio signals along the first digital audio data link to the first said circuit for supplying and/or receiving digital audio signals.

31. A method according to claim 29 in which the method further comprises transferring second digital audio signals from the second said circuit for supplying and/or receiving digital audio signals to the first said circuit for supplying and/or receiving digital audio signals, simultaneously with the said transferring of first digital audio signals from the first said circuit to the second said circuit, by:
(i) passing the second digital audio signals along the second digital audio data link to the second set of connectors of the said integrated circuit;
(ii) passing the second digital audio signals from the said second set of connectors to the first digital audio interface circuit of the integrated circuit,
(iii) passing the second digital audio signals within the integrated circuit, optionally after signal processing or mixing within the integrated circuit, through the first digital audio interface circuit or another digital audio interface circuit of the integrated circuit to the first set of connectors; and
(iv) passing the second digital audio signals along the first digital audio data link to the first said circuit for supplying and/or receiving digital audio signals.

32. A method according to claim 29 in which the method further comprises transferring second digital audio signals from the second said circuit for supplying and/or receiving digital audio signals through the integrated circuit, simultaneously with the said transferring of first digital audio signals from the first said circuit to the second said circuit, by:
(i) passing the second digital audio signals along the second digital audio data link to the second set of connectors of the said integrated circuit;
(ii) passing the second digital audio signals from the said second set of connectors to the first digital audio interface circuit of the integrated circuit,
(iii) passing the second digital audio signals within the integrated circuit, optionally after signal processing or mixing within the integrated circuit, either (a) to an output of the integrated circuit and then to an audio transducer, optionally after digital-to-analog conversion within the integrated circuit or (b) through the first digital audio interface circuit or another digital audio interface circuit of the integrated circuit to a third set of connectors and then along a third digital audio data link to a third circuit for supplying and/or receiving digital audio signals.

33. A method according to claim 29 in which the method further comprises transferring second digital audio signals through the integrated circuit to the first said circuit for supplying and/or receiving digital audio signals, simultaneously with the said transferring of first digital audio signals from the first said circuit to the second said circuit, by:
(i) either (a) receiving the second audio signals from an audio transducer via an input of the integrated circuit and, in the case that the second audio signals are received by the integrated circuit in analog form, converting them to digital form in the integrated circuit, or (b) passing the second digital audio signals from a third circuit for supplying and/or receiving digital audio signals along a third digital audio data link to a third set of connectors of the integrated circuit and then passing the second digital audio signals through the first digital audio interface circuit or another digital audio interface circuit of the integrated circuit;
(ii) passing the second digital audio signals within the integrated circuit to the first digital audio interface circuit, optionally after signal processing or mixing within the integrated circuit;
(iii) passing the second digital audio signals from the first digital audio interface circuit of the integrated circuit to the said first set of connectors; and
(iv) passing the second digital audio signals along the first digital audio data link to the first said circuit for supplying and/or receiving digital audio signals.

34. A method according to claim 29 in which the first digital data is transferred over the first digital audio data link serially together with a bit clock signal, that indicates the timing of serial data bits on the first digital audio data link, output onto the first digital audio data link by the first said circuit for supplying and/or receiving digital audio signals.

35. A method according to claim 29 in which the first digital data is transferred over the first digital audio data link serially together with a bit clock signal, that indicates the timing of serial data bits on the first digital audio data link, output onto the first digital audio data link by the second said circuit for supplying and/or receiving digital audio signals.

36. A method according to claim 29 in which the first digital data is transferred over the first digital audio data link serially together with a bit clock signal, that indicates the timing of serial data bits on the first digital audio data link, output onto the first digital audio data link by the said integrated circuit.

37. An integrated circuit for transferring audio signals between (i) audio transducers and (ii) circuits for supplying and/or receiving digital audio signals, the integrated circuit comprising:
(a) N sets of connectors, each set of connectors being suitable for connection to an audio data link for transferring digital audio data to or from one of the said circuits for supplying and/or receiving digital audio signals, wherein N is a number greater than 1;
(b) M digital audio interface circuits for processing signals that pass through the said sets of connectors so as to convert the audio data of the signals between the data format used in the audio link to which the set of connectors is connected and a data format, different from the data format used in the audio link, usable within the integrated circuit, wherein M is a number greater than zero and less than N; and
(c) a routing system connected between the said sets of connectors and the said digital audio interface circuit(s) and arranged to provide, for signals passing through each of the N sets of connectors, at least one of: (i) a route passing through another of the N sets of connectors without passing through any digital audio interface circuit on the route between the respective sets of connectors; and (ii) a route passing through one of said M digital audio interface circuits.

38. An integrated circuit according to claim 37 in which the routing system is arranged to provide, in respect of all the N sets of connectors, at least one route passing through one of said M digital audio interface circuits for digital audio data passing through the set of connectors.

39. An integrated circuit according to claim 37 in which the routing system is arranged to provide, for digital audio data passing through at least one the N sets of connectors, at least (i) a route passing through a first one of said M digital audio interface circuits and (ii) a route passing through a second one of said M digital audio interface circuits.

40. An integrated circuit according to claim 37 in which the routing system is arranged to provide, in respect of at least one of said N sets of connectors:
a route for digital audio data entering the integrated circuit through the set of connectors which route passes through one of (a) one of the M digital audio interface circuits, and (b) a different one of the N sets of connectors without passing through any digital audio interface circuit on the route between the respective sets of connectors; and
a route for digital audio data leaving the integrated circuit through the set of connectors which route passes through the other of (a) one of the M digital audio interface circuits, and (b) a different one of the N sets of connectors without passing through any digital audio interface circuit on the route between the respective sets of connectors.

41. An integrated circuit according to claim 1 comprising an input for receiving analog audio signals from an audio transducer and at least one analog-to-digital converter for converting the received analog audio signals to digital audio signals.

42. An integrated circuit according to claim 1 comprising at least one digital-to-analog converter for converting received digital audio signals to analog audio signals and an output for providing analog audio signals to an audio transducer.

43. An integrated circuit according to claim 1 which is suitable for incorporation into a portable wireless telephony device.

44. A portable wireless telephony device comprising an integrated circuit according to claim 1.

45. A portable cellular wireless telephony device comprising an integrated circuit according to claim 1.

46. An integrated circuit according to claim 22 comprising an input for receiving analog audio signals from an audio transducer and at least one analog-to-digital converter for converting the received analog audio signals to digital audio signals.

47. An integrated circuit according to claim 22 comprising at least one digital-to-analog converter for converting received digital audio signals to analog audio signals and an output for providing analog audio signals to an audio transducer.

48. An integrated circuit according to claim 22 which is suitable for incorporation into a portable wireless telephony device.

49. A portable wireless telephony device comprising an integrated circuit according to claim 22.

50. A portable cellular wireless telephony device comprising an integrated circuit according to claim 22.

51. An integrated circuit according to claim 23 comprising an input for receiving analog audio signals from an audio transducer and at least one analog-to-digital converter for converting the received analog audio signals to digital audio signals.

52. An integrated circuit according to claim 23 comprising at least one digital-to-analog converter for converting received digital audio signals to analog audio signals and an output for providing analog audio signals to an audio transducer.

53. An integrated circuit according to claim 23 which is suitable for incorporation into a portable wireless telephony device.

54. A portable wireless telephony device comprising an integrated circuit according to claim 23.

55. A portable cellular wireless telephony device comprising an integrated circuit according to claim 23.

56. An integrated circuit according to claim 37 comprising an input for receiving analog audio signals from an audio transducer and at least one analog-to-digital converter for converting the received analog audio signals to digital audio signals.

57. An integrated circuit according to claim 37 comprising at least one digital-to-analog converter for converting received digital audio signals to analog audio signals and an output for providing analog audio signals to an audio transducer.

58. An integrated circuit according to claim 37 which is suitable for incorporation into a portable wireless telephony device.

59. A portable wireless telephony device comprising an integrated circuit according to claim 37.

60. A portable cellular wireless telephony device comprising an integrated circuit according to claim 37.

61. An integrated circuit according to claim 1 in which each said set of connectors comprises at least (a) a first connector for receiving serial digital audio data from an audio link connected to the set of connectors, (b) a second connector for providing serial digital audio data to an audio link connected to the set of connectors, (c) a third connector for a bit clock signal that indicates the timing of serial data bits received by the first connector and provided by the second connector, and (d) a fourth connector for a synchronisation signal that indicates the timing of data words, data frames or other multi-bit data structures in at least one of (i) the serial digital audio data received by the first connector and (ii) the serial digital audio data provided by the second connector.

62. An integrated circuit according to claim 22 in which each said set of connectors comprises at least (a) a first connector for receiving serial digital audio data from an audio link connected to the set of connectors, (b) a second connector for providing serial digital audio data to an audio link connected to the set of connectors, (c) a third connector for a bit clock signal that indicates the timing of serial data bits received by the first connector and provided by the second connector, and (d) a fourth connector for a synchronisation signal that indicates the timing of data words, data frames or other multi-bit data structures in at least one of (i) the serial digital audio data received by the first connector and (ii) the serial digital audio data provided by the second connector.

63. An integrated circuit according to claim 23 in which each said set of connectors comprises at least (a) a first connector for receiving serial digital audio data from an audio link connected to the set of connectors, (b) a second connector for providing serial digital audio data to an audio link connected to the set of connectors, (c) a third connector for a bit clock signal that indicates the timing of serial data bits received by the first connector and provided by the second connector, and (d) a fourth connector for a synchronisation signal that indicates the timing of data words, data frames or other multi-bit data structures in at least one of (i) the serial digital audio data received by the first connector and (ii) the serial digital audio data provided by the second connector.

64. An integrated circuit according to claim 37 in which each said set of connectors comprises at least (a) a first connector for receiving serial digital audio data from an audio link connected to the set of connectors, (b) a second connector for providing serial digital audio data to an audio link connected to the set of connectors, (c) a third connector for a bit clock signal that indicates the timing of serial data bits received by the first connector and provided by the second connector, and (d) a fourth connector for a synchronisation signal that indicates the timing of data words, data frames or other multi-bit data structures in at least one of (i) the serial digital audio data received by the first connector and (ii) the serial digital audio data provided by the second connector.

65. An integrated circuit for routing audio data comprising:
at least first and second sets of terminals for inputting and/or outputting digital signals comprising audio data signals;
routing circuitry;
a data bus for transferring said audio data signals within the integrated circuit; and
at least one audio data interface coupled between said routing circuitry and said data bus;
wherein said routing circuitry is coupled between the said sets of terminals and the audio data interface and is controlled, in use, to select a route, from a plurality of available routes through the routing circuitry, for said audio digital signals.

66. An integrated circuit for routing audio data having:
one or more sets of terminals for inputting to the integrated circuit, and/or outputting from the integrated circuit, digital audio data and associated control and/or timing data;
a data bus for transferring said audio data signals within the integrated circuit;
one or more interface circuits, between said terminals and said data bus, for handling data passing through the terminals; and
a routing system between (a) said one or more sets of terminals and (b) said one or more interface circuits, so that there is a choice of routes for data passing through the terminals.

67. An integrated circuit for routing audio data having:
at least two sets of terminals for inputting to the integrated circuit, and/or outputting from the integrated circuit, digital audio data and associated control and/or timing data;
a data bus for transferring said audio data signals within the integrated circuit;
one or more interface circuits, between said terminals and said data bus, for handling data passing through the terminals; and
a routing system between (a) said at least two sets of terminals and (b) said one or more interface circuits, so that data received through a set of terminals may be routed to be output through another set of terminals without passing through any of the interface circuits on its path between the sets of terminals.

68. An integrated circuit for handling audio data having:
at least two sets of terminals for inputting to the integrated circuit, and/or outputting from the integrated circuit, digital audio data and associated control and/or timing data;
a data bus for transferring said audio data signals within the integrated circuit;
one or more interface circuits, between said terminals and said data bus, for handling data passing through the terminals,
said integrated circuit having a greater number of said sets of terminals than it has of said interface circuits, and at least one of said interface circuits being able to be coupled so as to handle, at different times, data passing through different ones of said sets of terminals.
